(19) United States
(12) Patent Application Publication
(10) Pub. No.: US 2014/0037002 A1
(43) Pub. Date: Feb. 6, 2014

(54) IMAGE PROCESSING APPARATUS AND IMAGE PROCESSING METHOD

(71) Applicant: Kazushi Sato, Tokyo (JP)

(72) Inventor: Kazushi Sato, Tokyo (JP)

(73) Assignee: Sony Corporation, Tokyo (JP)

(21) Appl. No.: 14/110,984

(22) PCT Filed: May 21, 2012
(86) PCT No.: PCT/JP2012/062925

§ 371 Date: Oct. 10, 2013

(30) Foreign Application Priority Data
Jun. 28, 2011 (JP) 2011-143271

(51) Int. Cl. H04N 7/32

(52) U.S. Cl. CPC H04N 19/00569
USPC 375/240.12

(57) ABSTRACT

Provided is an image processing apparatus including a mode setting section that, when a number of candidates of an intra prediction mode of a first prediction unit in a first layer of an image to be scalable-video-decoded containing the first layer and a second layer, which is an upper layer of the first layer, is different from the number of candidates of the intra prediction mode of a second prediction unit corresponding to the first prediction unit in the second layer, sets the prediction mode selected based on the prediction mode set to the first prediction unit to the second prediction unit, and a prediction section that generates a predicted image of the second prediction unit according to the prediction mode set by the mode setting section.

### TECHNICAL FIELD

The present disclosure relates to an image processing apparatus and an image processing method.

### BACKGROUND ART

Compression technology like the H.26x (ITU-T Q6/16 VCEG) standard and MPEG (Moving Picture Experts Group)-y standard that compresses the amount of information of images using redundancy specific to images have widely been used for the purpose of efficiently transmitting or accumulating digital images. In Joint Model of Enhanced-Compression Video Coding as part of activity of MPEG4, international standards called H.264 and MPEG-4 Part10 (Advanced Video Coding; AVC) capable of realizing a higher compression rate by incorporating new functions based on the H.26x standard have been laid down.

One important technology in these image coding methods is a prediction inside an image, that is, an intra prediction. The intra prediction is a technology that reduces the amount of information to be encoded by using correlations between neighboring blocks inside an image to predict a pixel value in a certain block from the pixel value of another neighboring block. In image coding methods before MPEG4, only DC components and low-frequency components of orthogonal transformation coefficients are intended for intra prediction, but in H.264/AVC, the intra prediction can be made for all image components. By using the intra prediction, a vast improvement in compression rate can be expected for images in which the pixel value changes slightly like, for example, an image of a blue sky.

In H.264/AVC, the intra prediction is made using a block of, for example, 4×4 pixels, 8×8 pixels, or 16×16 pixels as a processing unit (that is, a prediction unit (PU)). In HEVC (High Efficiency Video Coding) whose standardization is under way as a next-generation image coding method subsequent to H.264/AVC, the size of the prediction unit is about to be extended to 32×32 pixels and 64×64 pixels (see Non-Patent Literature 1 below).

When an intra prediction is made, the optimum prediction mode to predict the pixel value of a block to be predicted is normally selected from a plurality of prediction modes. The prediction mode can typically be distinguished based on the prediction direction from a reference pixel to a pixel to be predicted. For the prediction unit of 4×4 pixels or 8×8 pixels of a luminance component in H.264/AVC, nine prediction modes corresponding to eight prediction directions (vertical, horizontal, diagonal down left, diagonal down right, vertical right, horizontal down, vertical left, horizontal up) and a DC (average value) prediction can be selected (see FIGS. 22 and 23). For the prediction unit of 16×16 pixels, four prediction modes corresponding to two prediction directions (vertical, horizontal), the DC (average value) prediction, and a plane prediction can be selected (see FIG. 24). In HEVC, as described above, not only the range of size of the PU is extended, but also an angular intra prediction method is adopted, which increases the number of prediction direction candidates (see Non-Patent Literature 2 below).

On the other hand, another important technology in the aforementioned image coding method is scalable video coding (SVC). The scalable video coding is a technology that hierarchically encodes a layer transmitting a rough image signal and a layer transmitting a fine image signal. Typical attributes hierarchized in the scalable video coding mainly include the following three:
Space scalability: Spatial resolutions or image sizes are hierarchized.
Time scalability: Frame rates are hierarchized.
SNR (Signal to Noise Ratio) scalability: SN ratios are hierarchized.

Further, though not yet adopted in the standard, the bit depth scalability and chroma format scalability are also discussed.

### CITATION LIST

### Non-Patent Literature

Non-Patent Literature 1: Sung-Chang Lim, Hahyun Lee, et al. “Intra coding using extended block size” (VCEG-AL28, July 2009)
Non-Patent Literature 2: Kemal Ugur, et al. “Description of video coding technology proposal by Tandberg, Nokia, Ericsson” (JCTVC-A119, April 2010)

### SUMMARY OF INVENTION

### Technical Problem

However, from the viewpoint of coding efficiency, encoding the prediction mode separately for each layer in the scalable video coding is not most suitable. If candidate sets of prediction mode are equal between the prediction unit of a lower layer and the corresponding prediction unit of an upper layer, prediction modes set for the lower layer can be reused for the upper layer. However, in some cases in which block sizes are different between layers, candidate sets of prediction mode are different and thus, prediction modes cannot be simply reused. Such circumstances are more apparent in HEVC in which the range of block size is extended and candidate sets of prediction mode are diversified.

Therefore, it is desirable that a mechanism capable of efficiently encoding the prediction mode of intra prediction in the scalable video coding be provided.

### Solution to Problem

According to an embodiment of the present disclosure, there is provided an image processing apparatus including a mode setting section that, when a number of candidates of an intra prediction mode of a first prediction unit in a first layer of an image to be scalable-video-decoded containing the first layer and a second layer, which is an upper layer of the first layer, is different from the number of candidates of the intra prediction mode of a second prediction unit corresponding to the first prediction unit in the second layer, sets the prediction mode selected based on the prediction mode set to the first prediction unit to the second prediction unit, and a prediction section that generates a predicted image of the second prediction unit according to the prediction mode set by the mode setting section.

The image processing device mentioned above may be typically realized as an image decoding device that decodes a scalable-video-coded image.

According to an embodiment of the present disclosure, there is provided an image processing method including when a number of candidates of an intra prediction mode of a first prediction unit in a first layer of an image to be scalable-video-decoded containing the first layer and a second layer, which is an upper layer of the first layer, is different from the number of candidates of the intra prediction mode of a second prediction unit corresponding to the first prediction unit in the second layer, setting the prediction mode selected based on the prediction mode set to the first prediction unit to the second prediction unit, and generating a predicted image of the second prediction unit according to the set prediction mode.

According to an embodiment of the present disclosure, there is provided an image processing apparatus including a mode setting section that, when a number of candidates of an intra prediction mode of a first prediction unit in a first layer of an image to be scalable-video-coded containing the first layer and a second layer, which is an upper layer of the first layer, is different from the number of candidates of the intra prediction mode of a second prediction unit corresponding to the first prediction unit in the second layer, sets the prediction mode selected based on the prediction mode set to the first prediction unit to the second prediction unit, and a prediction section that generates a predicted image of the second prediction unit according to the prediction mode set by the mode setting section.

The image processing device mentioned above may be typically realized as an image encoding device that scalably encodes an image.

According to an embodiment of the present disclosure, there is provided an image processing method including when a number of candidates of an intra prediction mode of a first prediction unit in a first layer of an image to be scalable-video-coded containing the first layer and a second layer, which is an upper layer of the first layer, is different from the number of candidates of the intra prediction mode of a second prediction unit corresponding to the first prediction unit in the second layer, setting the prediction mode selected based on the prediction mode set to the first prediction unit to the second prediction unit, and generating a predicted image of the second prediction unit according to the set prediction mode.

### Advantageous Effects of Invention

According to the present disclosure, a mechanism capable of efficiently encoding the prediction mode of intra prediction in the scalable video coding is provided.

### BRIEF DESCRIPTION OF DRAWINGS

FIG. 1 is a block diagram showing a configuration of an image coding device according to an embodiment.

FIG. 2 is an explanatory view illustrating space scalability.

FIG. 3 is a block diagram showing an example of a detailed configuration of an intra prediction section of the image coding device according to the embodiment.

FIG. 4 is an explanatory view illustrating prediction direction candidates that can be selected in an angular intra prediction method of HEVC.

FIG. 5 is an explanatory view illustrating a calculation of a reference pixel value in the angular intra prediction method of HEVC.

FIG. 6 is an explanatory view illustrating a parameter generated when a prediction mode is extended.

FIG. 7A is a first explanatory view illustrating a modification of the parameter generated when the prediction mode is extended.

FIG. 7B is a second explanatory view illustrating a modification of the parameter generated when the prediction mode is extended.

FIG. 8 is a first explanatory view illustrating an aggregation of the prediction mode.

FIG. 9 is a second explanatory view illustrating the aggregation of the prediction mode.

FIG. 10 is an explanatory view illustrating a modification of the aggregation of the prediction mode.

FIG. 11 is an explanatory view illustrating a prediction of the prediction mode by Most Probable Mode.

FIG. 12 is a flow chart showing an example of a flow of an intra prediction process at the time of encoding according to an embodiment.

FIG. 13 is a flow chart showing an example of a detailed flow of a prediction mode extension process in FIG. 12.

FIG. 14A is a flow chart showing a first example of the detailed flow of a prediction mode aggregation process in FIG. 12.

FIG. 14B is a flow chart showing a second example of the detailed flow of the prediction mode aggregation process in FIG. 12.

FIG. 15 is a block diagram showing an example of a configuration of an image decoding device according to an embodiment.

FIG. 16 is a block diagram showing an example of a detailed configuration of an intra prediction section of the image decoding device according to the embodiment.

FIG. 17 is a flow chart showing an example of a flow of an intra prediction process at the time of decoding according to an embodiment.

FIG. 18 is a block diagram showing an example of a schematic configuration of a television.

FIG. 19 is a block diagram showing an example of a schematic configuration of a mobile phone.

FIG. 20 is a block diagram showing an example of a schematic configuration of a recording/reproduction device.

FIG. 21 is a block diagram showing an example of a schematic configuration of an image capturing device.

FIG. 22 is an explanatory view showing candidate sets of the prediction mode of a luminance component in the prediction unit of 4×4 pixels in H.264/AVC.

FIG. 23 is an explanatory view showing candidate sets of the prediction mode of the luminance component in the prediction unit of 8×8 pixels.

FIG. 24 is an explanatory view showing candidate sets of the prediction mode of the luminance component in the prediction unit of 16×16 pixels.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

Furthermore, the “Description of Embodiments” will be described in the order mentioned below.

1. Example Configuration of Image Encoding Device According to an Embodiment

2. Flow of Process at the Time of Encoding According to an Embodiment

3. Example Configuration of Image Decoding Device According to an Embodiment

4. Flow of Process at the Time of Decoding According to an Embodiment

5. Example Application

6. Summary

### 1. Example Configuration of Image Encoding Device According to an Embodiment

[1-1. Example of Overall Configuration]

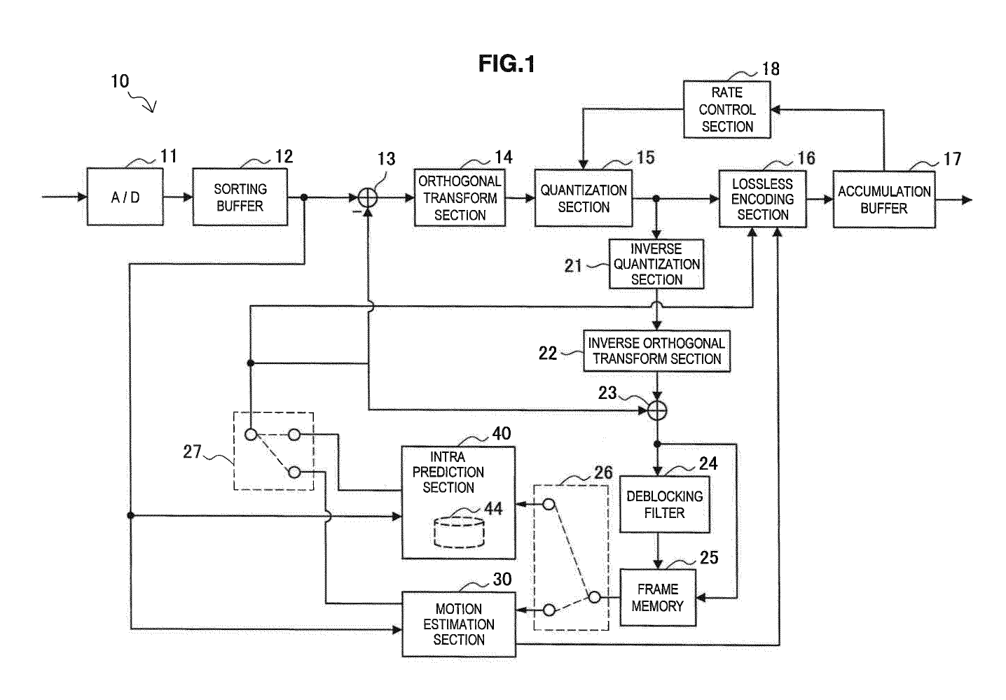

FIG. 1 is a block diagram showing an example of a configuration of an image encoding device 10 according to an embodiment. Referring to FIG. 1, the image encoding device 10 includes an A/D (Analogue to Digital) conversion section 11, a sorting buffer 12, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a deblocking filter 24, a frame memory 25, selectors 26 and 27, a motion estimation section 30 and an intra prediction section 40.

The A/D conversion section 11 converts an image signal input in an analogue format into image data in a digital format, and outputs a series of digital image data to the sorting buffer 12.

The sorting buffer 12 sorts the images included in the series of image data input from the A/D conversion section 11. After sorting the images according to the a GOP (Group of Pictures) structure according to the encoding process, the sorting buffer 12 outputs the image data which has been sorted to the subtraction section 13, the motion estimation section 30 and the intra prediction section 40.

The image data input from the sorting buffer 12 and predicted image data input by the motion estimation section 30 or the intra prediction section 40 described later are supplied to the subtraction section 13. The subtraction section 13 calculates predicted error data which is a difference between the image data input from the sorting buffer 12 and the predicted image data and outputs the calculated predicted error data to the orthogonal transform section 14.

The orthogonal transform section 14 performs orthogonal transform on the predicted error data input from the subtraction section 13. The orthogonal transform to be performed by the orthogonal transform section 14 may be discrete cosine transform (DCT) or Karhunen-Loeve transform, for example. The orthogonal transform section 14 outputs transform coefficient data acquired by the orthogonal transform process to the quantization section 15.

The transform coefficient data input from the orthogonal transform section 14 and a rate control signal from the rate control section 18 described later are supplied to the quantization section 15. The quantization section 15 quantizes the transform coefficient data, and outputs the transform coefficient data which has been quantized (hereinafter, referred to as quantized data) to the lossless encoding section 16 and the inverse quantization section 21. Also, the quantization section 15 switches a quantization parameter (a quantization scale) based on the rate control signal from the rate control section 18 to thereby change the bit rate of the quantized data to be input to the lossless encoding section 16.

The lossless encoding section 16 generates an encoded stream by performing a lossless encoding process on the quantized data input from the quantization section 15. The lossless encoding by the lossless encoding section 16 may be variable-length coding or arithmetic coding, for example. Furthermore, the lossless encoding section 16 multiplexes the information about intra prediction or the information about inter prediction input from the selector 27 to the header region of the encoded stream. Then, the lossless encoding section 16 outputs the generated encoded stream to the accumulation buffer 17.

The accumulation buffer 17 temporarily accumulates an encoded stream input from the lossless encoding section 16 using a storage medium such as a semiconductor memory. Then, the accumulation buffer 17 outputs the accumulated encoded stream to a transmission section (not shown) (for example, a communication interface or an interface to peripheral devices) at a rate in accordance with the band of a transmission path.

The rate control section 18 monitors the free space of the accumulation buffer 17. Then, the rate control section 18 generates a rate control signal according to the free space on the accumulation buffer 17, and outputs the generated rate control signal to the quantization section 15. For example, when there is not much free space on the accumulation buffer 17, the rate control section 18 generates a rate control signal for lowering the bit rate of the quantized data. Also, for example, when the free space on the accumulation buffer 17 is sufficiently large, the rate control section 18 generates a rate control signal for increasing the bit rate of the quantized data.

The inverse quantization section 21 performs an inverse quantization process on the quantized data input from the quantization section 15. Then, the inverse quantization section 21 outputs transform coefficient data acquired by the inverse quantization process to the inverse orthogonal transform section 22.

The inverse orthogonal transform section 22 performs an inverse orthogonal transform process on the transform coefficient data input from the inverse quantization section 21 to thereby restore the predicted error data. Then, the inverse orthogonal transform section 22 outputs the restored predicted error data to the addition section 23.

The addition section 23 adds the restored predicted error data input from the inverse orthogonal transform section 22 and the predicted image data input from the motion estimation section 30 or the intra prediction section 40 to thereby generate decoded image data. Then, the addition section 23 outputs the generated decoded image data to the deblocking filter 24 and the frame memory 25.

The deblocking filter 24 performs a filtering process for reducing block distortion occurring at the time of encoding of an image. The deblocking filter 24 filters the decoded image data input from the addition section 23 to remove the block distortion, and outputs the decoded image data after filtering to the frame memory 25.

The frame memory 25 stores, using a storage medium, the decoded image data input from the addition section 23 and the decoded image data after filtering input from the deblocking filter 24.

The selector 26 reads the decoded image data after filtering which is to be used for inter prediction from the frame memory 25, and supplies the decoded image data which has been read to the motion estimation section 30 as reference image data. Also, the selector 26 reads the decoded image data before filtering which is to be used for intra prediction from the frame memory 25, and supplies the decoded image data which has been read to the intra prediction section 40 as reference image data.

In the inter prediction mode, the selector 27 outputs predicted image data as a result of inter prediction output from the motion estimation section 30 to the subtraction section 13 and also outputs information about the inter prediction to the lossless encoding section 16. In the intra prediction mode, the selector 27 outputs predicted image data as a result of intra prediction output from the intra prediction section 40 to the subtraction section 13 and also outputs information about the intra prediction to the lossless encoding section 16. The selector 27 switches the inter prediction mode and the intra prediction mode in accordance with the magnitude of a cost function value output from the motion estimation section 30 and the intra prediction section 40.

The motion estimation section 30 performs an inter prediction process (inter-frame prediction process) based on image data (original image data) to be encoded and input from the sorting buffer 12 and decoded image data supplied via the selector 26. For example, the motion estimation section 30 evaluates prediction results in each prediction mode using a predetermined cost function. Next, the motion estimation section 30 selects the prediction mode in which the cost function value takes the minimum value, that is, the prediction mode in which the compression rate is the highest as the optimum prediction mode. Also, the motion estimation section 30 generates predicted image data according to the optimum prediction mode. Then, the motion estimation section 30 outputs prediction mode information indicating the selected optimum prediction mode, information about the inter prediction including motion vector information and reference pixel information, the cost function value, and predicted image data to the selector 27.

The intra prediction section 40 performs an intra prediction process for each block set inside an image based on original image data input from the sorting buffer 12 and decoded image data as reference image data supplied from the frame memory 25. Then, the intra prediction section 40 outputs information about the intra prediction including prediction mode information indicating the optimum prediction mode, the cost function value, and predicted image data to the selector 27.

In the present embodiment, the number of prediction mode candidates that can be selected by the intra prediction section 40 is different depending on the block size of the prediction unit. When, for example, the aforementioned angular intra prediction method is adopted, the number of prediction mode candidates by block size is as shown in Table 1 below:

TABLE 1
Number of intra prediction mode candidates by PU size

| | | Number of Possible | Number of Possible |
|---|---|---|---|
| Log₂(PU Size) | PU Size | Intra Prediction Modes | Prediction Directions |
| 2 | 4 × 4 | 17 | 16 |
| 3 | 8 × 8 | 34 | 33 |
| 4 | 16 × 16 | 34 | 33 |
| 5 | 32 × 32 | 34 | 33 |
| 6 | 64 × 64 | 3 | 2 |

That is, when the block size is 4×4 pixels, the number of prediction mode candidates (Possible Intra Prediction Modes) is 17. Of these prediction mode candidates, 16 prediction modes excluding a prediction mode corresponding to the DC prediction each correspond to 16 prediction direction candidates (Possible Prediction Directions) from the reference pixel to a pixel to be predicted. When the block size is 8×8 pixels, the number of prediction mode candidates is 34. Of these prediction mode candidates, 33 prediction modes excluding a prediction mode corresponding to the DC prediction each correspond to 33 prediction direction candidates from the reference pixel to a pixel to be predicted. Also when the block size is 16×16 pixels or 32×32 pixels, similarly 34 prediction mode candidates and 33 prediction direction candidates are present. When the block size is 64×64, the number of prediction mode candidates is three. Of these prediction mode candidates, two prediction modes excluding a prediction mode corresponding to the DC prediction each correspond to two prediction direction candidates (vertical and horizontal) from the reference pixel to a pixel to be predicted.

The image encoding device 10 repeats a series of encoding processes described here for each of a plurality of layers of an image to be scalable-video-coded. The layer to be encoded first is a layer called a base layer representing the roughest image. An encoded stream of the base layer may be independently decoded without decoding encoded streams of other layers. Layers other than the base layer are layers called enhancement layer representing finer images. Information contained in an encoded stream of the base layer is used for an encoded stream of an enhancement layer to enhance the coding efficiency. Therefore, to reproduce an image of an enhancement layer, encoded streams of both of the base layer and the enhancement layer are decoded. The number of layers handled in scalable video coding may be three or more. In such a case, the lowest layer is the base layer and remaining layers are enhancement layers. For an encoded stream of a higher enhancement layer, information contained in encoded streams of a lower enhancement layer and the base layer may be used for encoding and decoding. In this specification, of at least two layers having dependence, the layer on the side depended on is called a lower layer and the layer on the depending side is called an upper layer.

In scalable video coding by the image encoding device 10, the prediction mode of an upper layer is predicted based on the prediction mode of a lower layer in intra prediction blocks to efficiently encode the prediction mode of intra prediction. A mode buffer 44 of the intra prediction section 40 shown in FIG. 1 is provided to temporarily store prediction mode information of lower layers. When the numbers of intra prediction mode candidates are equal between layers, the same prediction mode as the prediction mode set to the prediction unit of a lower layer may be set to the corresponding prediction unit of an upper layer as it is. However, when, for example, space scalability or chroma format scalability is adopted, cases in which block sizes of two prediction units corresponding to each other are different exist and thus, circumstances in which the numbers of intra prediction mode candidates are different between layers can arise.

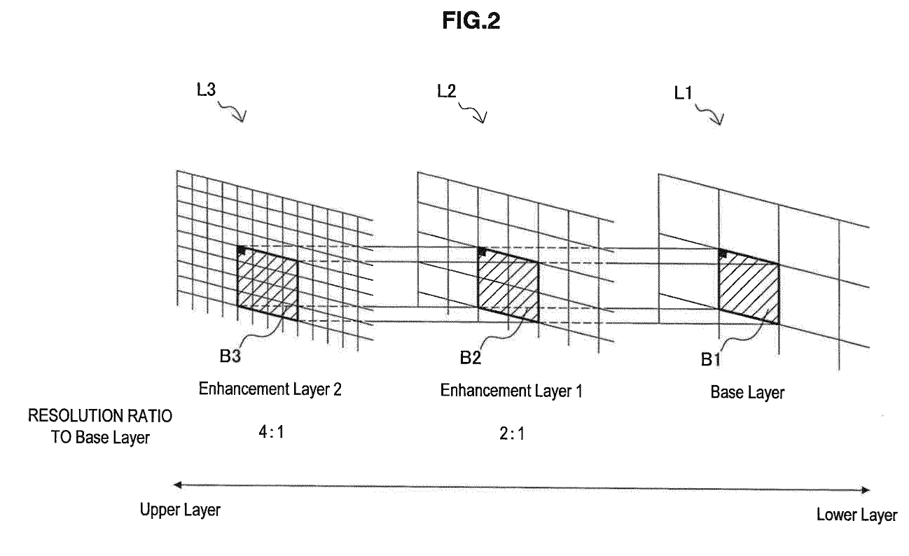

FIG. 2 shows, as an example of space scalability, three layers L1, L2, L3 that are scalable-video-coded. The layer L1 is the base layer and the layers L2, L3 are enhancement layers. The ratio of spatial resolution of the layer L2 to the layer L1 is 2:1. The ratio of spatial resolution of the layer L3 to the layer L1 is 4:1. In this case, the block size of a prediction unit B2 of the layer L2 is twice the block size (on one side) of a prediction unit B1 corresponding to the layer L1. The block size of a prediction unit B3 of the layer 13 is twice the block size of the prediction unit B2 corresponding to the layer L2 and four times the block size of the prediction unit B1 corresponding to the layer L1.

When, in the example of Table 1, for example, the block size of a lower layer is 4×4 pixels and the block size of an upper layer is 8×8 pixels, 16×16 pixels, or 32×32 pixels, the number of prediction mode candidates of the lower layer is less than the number of prediction mode candidates of the upper layer. On the other hand, when the block size of a lower layer is 32×32 pixels and the block size of an upper layer is 64×64 pixels, the number of prediction mode candidates of the lower layer is more than the number of prediction mode candidates of the upper layer. In such circumstances, as will be described in detail in the next section, the intra prediction section 40 of the image encoding device 10 predicts the prediction mode of the upper layer based on the prediction mode of the lower layer by extending or aggregating the prediction mode.

The prediction unit of the lower layer corresponding to the prediction unit of the upper layer may be, for example, the prediction unit of the lower layer having a pixel corresponding to a pixel in a predetermined position (for example, upper left) of the prediction unit of the upper layer. Based on the above definition, even if a prediction unit of the upper layer that integrates a plurality of prediction units of the lower layer exists, the prediction unit of the lower layer corresponding to the prediction unit of the upper layer can uniquely be decided.

Also in this specification, examples in which the aforementioned angular intra prediction method is used by the intra prediction section 40 have mainly been described. However, the technology according to the present disclosure is not limited to such examples and can generally be applied to circumstances in which the numbers of intra prediction mode candidates are different between layers for scalable video coding.

[1-2. Configuration Example of Intra Prediction Section]

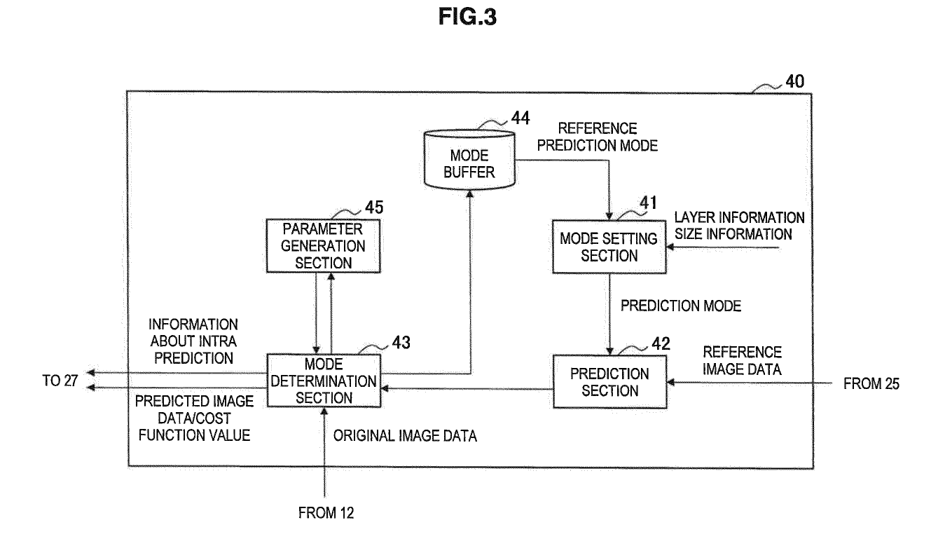

FIG. 3 is a block diagram showing an example of a detailed configuration of the intra prediction section 40 of the image encoding device 10 shown in FIG. 1. Referring to FIG. 3, the intra prediction section 40 includes a mode setting section 41, a prediction section 42, a mode determination section 43, a mode buffer 44, and a parameter generation section 45.

In an intra prediction process of a base layer, the mode setting section 41 successively sets each of a plurality of prediction mode candidates to one or more prediction units in a coding unit. The prediction section 42 generates a predicted image of each prediction unit using reference image data input from the frame memory 25 according to the prediction mode candidate set by the mode setting section 41. The mode determination section 43 calculates a cost function value of each prediction mode candidate based on original image data input from the sorting buffer 12 and predicted image data input from the prediction section 42. Then, the mode determination section 43 determines the optimum arrangement of prediction units in a coding unit and the optimum prediction mode based on the calculated cost function value. The mode buffer 44 temporarily stores prediction mode information indicating the decided optimum prediction mode using a storage medium for a process in an upper layer. The parameter generation section 45 generates parameters representing the arrangement of prediction units and the prediction mode determined to be optimum by the mode determination section 43. Then, the mode determination section 43 outputs information about intra prediction including parameters generated by the parameter generation section 45, the cost function value, and predicted image data to the selector 27.

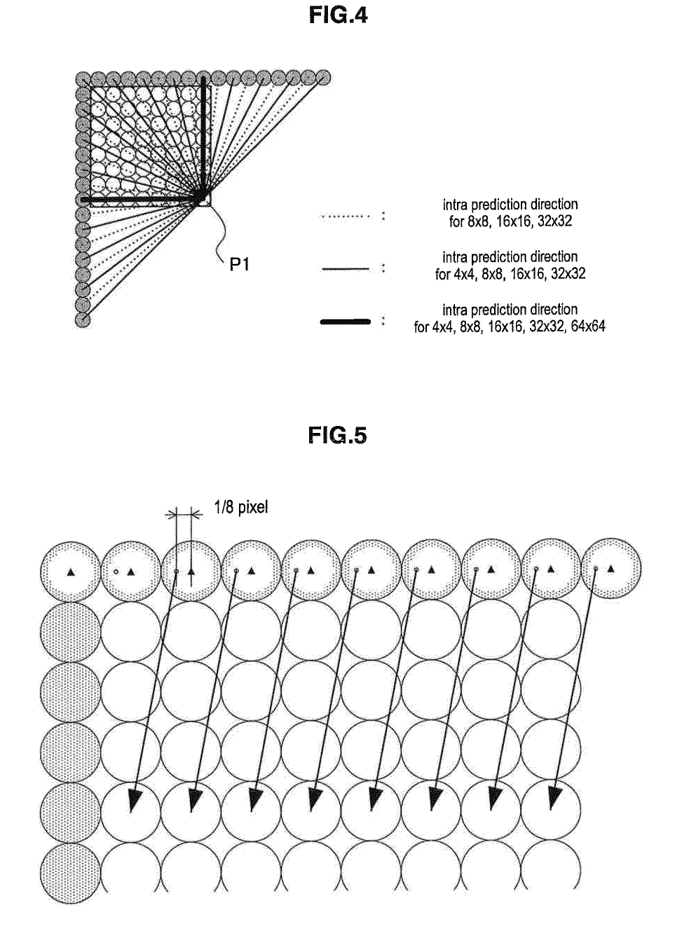

FIG. 4 is an explanatory view illustrating prediction direction candidates that can be selected when the angular intra prediction method is used for such an intra prediction. A pixel P1 shown in FIG. 4 is a pixel to be predicted. Shaded pixels around the block to which the pixel P1 belongs are reference pixels. When the block size is 4×4 pixels, (in addition to the DC prediction), (prediction modes corresponding to) 17 prediction directions indicated by solid lines (both thick lines and thin lines) in FIG. 4 and connecting the reference pixels and the pixel to be predicted can be selected. When the block size is 8×8 pixels, 16×16 pixels, or 32×32 pixels, (in addition to the DC prediction and plane prediction), (prediction modes corresponding to) 33 prediction directions indicated by dotted lines and solid lines (both thick lines and thin lines) in FIG. 4 can be selected. When the block size is 64×64 pixels, (in addition to the DC prediction), (prediction modes corresponding to) two prediction directions indicated by thick lines in FIG. 4 can be selected. The mode setting section 41 shown in FIG. 3 sets these prediction mode candidates to each prediction unit in accordance with the size of each prediction unit.

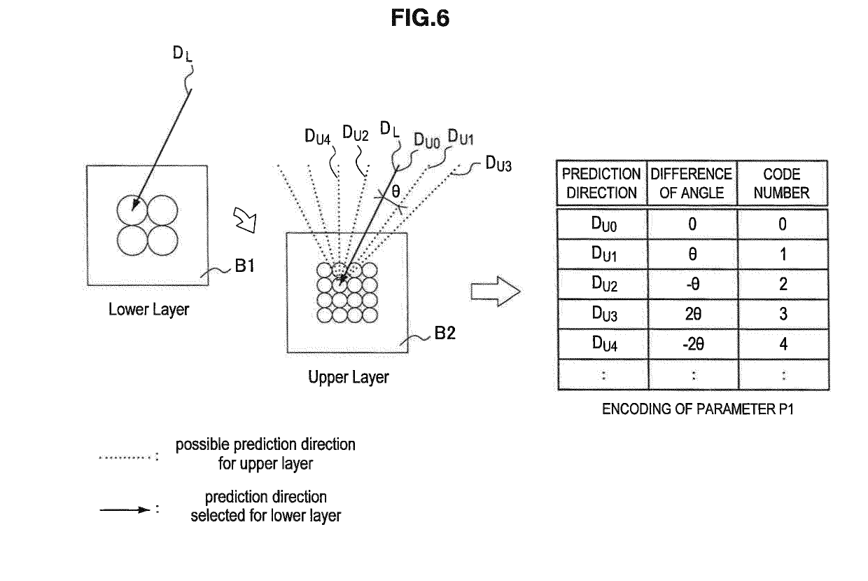

In the aforementioned angular intra prediction method, the resolution of the angle in the prediction direction is high and, for example, a difference of angle between neighboring prediction directions when the block size is, for example, 8×8 pixels is 180 degrees/32=5.625 degrees. Therefore, the prediction unit 42 first calculates a reference pixel value of 1/8 pixel accuracy as shown in FIG. 5 and then calculates a predicted pixel value according to each prediction mode candidate using the calculated reference pixel value.

Intra prediction processes of enhancement layers can mainly be divided into three types of the reuse of the prediction direction, extension of the prediction direction, and aggregation of the prediction direction. In the present embodiment, the reuse of the prediction direction is carried out when the number of prediction mode candidates of the lower layer is equal to the number of prediction mode candidates of the upper layer. The extension of the prediction direction is carried out when the number of prediction mode candidates of the lower layer is smaller than the number of prediction mode candidates of the upper layer. The aggregation of the prediction direction is carried out when the number of prediction mode candidates of the lower layer is larger than the number of prediction mode candidates of the upper layer. However, the present embodiment is not limited to such examples and when the number of prediction mode candidates of the lower layer is smaller than the number of prediction mode candidates of the upper layer, for example, the reuse of the prediction direction may be carried out instead of the extension of the prediction direction.

(1) Reuse of the Prediction Direction

When the number of prediction mode candidates of the lower layer is equal to the number of prediction mode candidates of the upper layer in an intra prediction process of an enhancement layer, the mode setting section 41 reuses the prediction mode indicated by prediction mode information stored in the mode buffer 44. That is, in this case, the mode setting section 41 sets the same prediction mode as the prediction mode set to the corresponding prediction unit of the lower layer to each prediction unit of the upper layer. The prediction section 42 generates a predicted image of each prediction unit according to one prediction mode set by the mode setting section 41. When the reuse of the prediction direction is carried out, the determination of the optimum prediction mode by the mode determination section 43 based on the cost function value is omitted (the cost function value may be calculated). When a still higher layer is present, the mode buffer 44 stores prediction mode information indicating the prediction mode set by the mode setting section 41.

(2) Extension of the Prediction Direction

When the number of prediction mode candidates of the lower layer is smaller than the number of prediction mode candidates of the upper layer, the mode setting section 41 successively sets each prediction mode candidate selected based on the prediction mode set to the corresponding prediction unit of the lower layer to each prediction unit of the upper layer.

Normally, there is a correlation between partial images in the same position between blocks corresponding to two layers that are different only in spatial resolution. Therefore, the optimum prediction mode in a certain block of the lower layer is most likely the optimum prediction mode in the corresponding block of the upper layer. However, if the resolution of the angle in the prediction direction is higher in the upper layer, the optimum prediction mode may be different resulting from a difference in resolution. Therefore, in this case, instead of simply reusing the prediction mode, the optimum prediction mode in the upper layer may be estimated to be able to enhance the coding efficiency by improving prediction accuracy. The range of estimating the prediction mode may be limited to some prediction directions in the neighborhood of the prediction direction set in the lower layer to reduce process costs.

The prediction section 42 generates a predicted image of each prediction unit using reference image data input from the frame memory 25 according to each prediction mode candidate set by the mode setting section 41. The mode determination section 43 calculates a cost function value of each prediction mode candidate based on original image data and predicted image data input from the prediction section 42. Then, the mode determination section 43 determines the optimum prediction mode based on the calculated cost function value. When a still higher layer is present, the mode buffer 44 stores prediction mode information indicating the optimum prediction mode decided by the mode determination section 43.

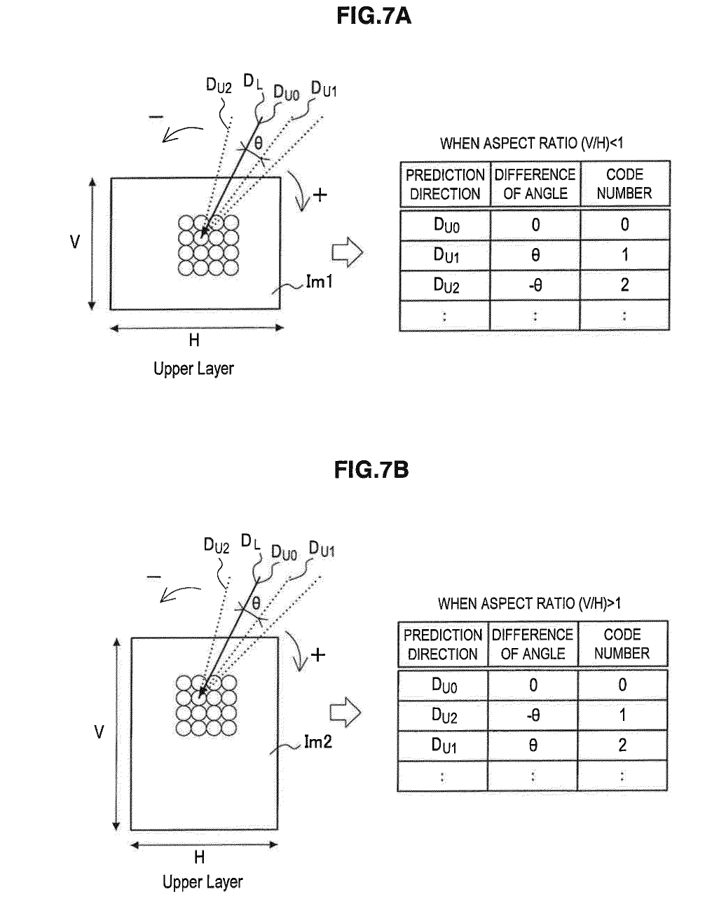

The parameter generation section 45 generates a parameter P1 as illustrated in FIG. 6 that is encoded according to a difference between the prediction mode set in the lower layer and the optimum prediction mode decided by the mode determination section 43.

Referring to FIG. 6, the prediction unit B1 of the lower layer and the prediction unit B2 of the lower layer corresponding to each other are shown. As an example, the size of the prediction unit B1 is 4×4 pixels and the size of the prediction unit B2 is 8×8 pixels. A prediction direction D_{L} is the prediction direction of the prediction mode set to the prediction unit B1. Prediction direction candidates of the prediction mode that can be set to the prediction unit B2 include prediction directions D_{U0}, D_{U1}, D_{U2}, D_{U3}, D_{U4} . . . . The difference of angle between two neighboring prediction direction candidates is θ.

As shown in the right table of FIG. 6, the parameter P1 is encoded with a smaller code number with a decreasing absolute value of a difference of the prediction directions. If, for example, the optimum prediction mode set to the prediction unit B2 is the prediction mode representing the prediction direction D_{U0}, the difference of angle is zero and the parameter P1 is encoded with the code number “0”. If the optimum prediction mode set to the prediction unit B2 is the prediction mode representing the prediction direction D_{U1} or D_{U2}, the difference of angle is θ or −θ and the parameter P1 is encoded with the code number “1” or “2”. If the optimum prediction mode set to the prediction unit B2 is the prediction mode representing the prediction direction D_{U3} or D_{U4}, the difference of angle is 2θ or −2θ and the parameter P1 is encoded with the code number “3” or “4”. A smaller code number is mapped to a shorter code word by the lossless encoding section 16. Therefore, by using a smaller code number with a decreasing difference (of angle) in prediction directions concerning the parameter P1 as described above, a prediction mode of high occurrence frequency in the upper layer is caused to be mapped to a shorter code word to be able to enhance the coding efficiency.

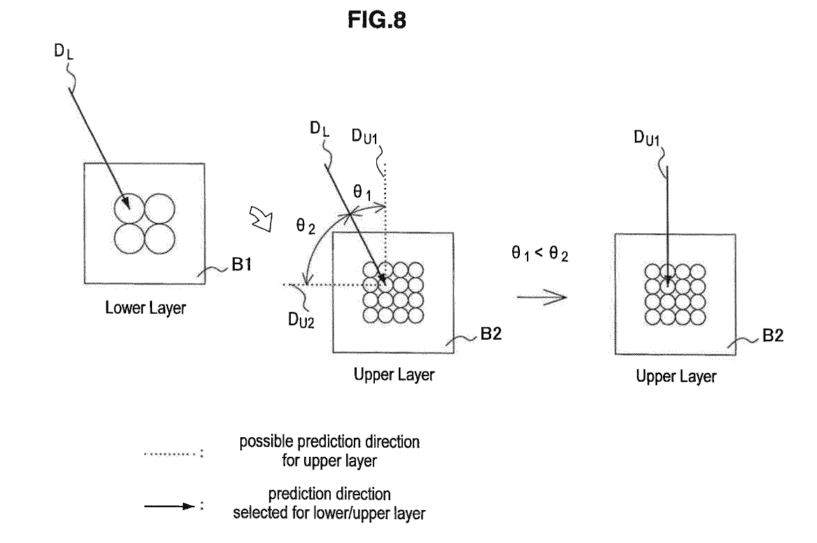

In the example of FIG. 6, a smaller code number is allocated to, between differences of the prediction direction that are different only in whether positive or negative, the difference that rotates the prediction direction clockwise from the lower layer to the upper layer. Thus, regarding two prediction modes having an equal absolute value of a difference in the prediction direction, a smaller code number may be allocated to any pre-defined prediction mode. Instead, as shown in FIGS. 7A and 7B, which specific direction (for example, vertical or horizontal) is approached by the prediction direction of the upper layer when one of prediction modes is selected may dynamically be determined to allocate a smaller code number to the prediction direction approaching the specific direction.

Referring to FIG. 7A, prediction direction candidates D_{U0}, D_{U1}, D_{U2} . . . of the prediction mode that can be set to a prediction unit of the upper layer of an image 1 ml are shown. The prediction direction of the prediction mode set to the lower layer is the prediction direction D_{L}. Here, the aspect ratio (vertical/horizontal) V/H of the image 1 ml is smaller than 1 (that is, the horizontal size is larger than the vertical size). In such a landscape image, prediction accuracy tends to improve when an intra prediction is made in a prediction direction closer to the horizontal direction. Thus, in this case, it is desirable to allocate a smaller code number to, between two prediction modes having an equal absolute value of a difference of the prediction direction, the prediction mode whose prediction direction in the upper layer is closer to the horizontal direction. In the example of FIG. 7A, the prediction direction D_{U1} is closer to the horizontal direction than the prediction direction D_{U2}. Therefore, in the right table of FIG. 7A, the parameter P1 is encoded with the code number “1” for the prediction mode representing the prediction direction D_{U1} and the parameter P1 is encoded with the code number “2” for the prediction mode representing the prediction direction D_{U2}. In the example of FIG. 7B, on the other hand, the aspect ratio (vertical/horizontal) V/H of an image Im2 is larger than 1 (that is, the horizontal size is smaller than the vertical size). Thus, in this case, it is desirable to allocate a smaller code number to, between two prediction modes having an equal absolute value of a difference of the prediction direction, the prediction mode whose prediction direction in the upper layer is closer to the vertical direction. Therefore, in the right table of FIG. 7B, the parameter P1 is encoded with the code number “1” for the prediction mode representing the prediction direction D_{U2} and the parameter P1 is encoded with the code number “2” for the prediction mode representing the prediction direction D_{U1}. Such mapping between the difference of angle and the code number regarding the parameter P1 may adaptively be decided in accordance with the aspect ratio of an image to be encoded.

(3) Aggregation of the Prediction Direction

When the number of prediction mode candidates of the lower layer is larger than the number of prediction mode candidates of the upper layer, the mode setting section 41 sets the prediction mode candidate selected based on the prediction mode set to the corresponding prediction unit of the lower layer to each prediction unit of the upper layer.

Normally, as described above, the optimum prediction mode in a prediction unit of the lower layer of two layers that are different only in spatial resolution is most likely the optimum prediction mode in the corresponding prediction unit of the upper layer. However, when the number of prediction mode candidates in the lower layer is larger, the prediction mode representing the same prediction direction in the lower layer may not be selectable in the upper layer. Therefore, in such a case, instead of simply reusing the prediction mode, the mode setting section 41 predicts the optimum prediction mode in the upper layer from the prediction mode set in the lower layer. In the present embodiment, the prediction mode predicted as the optimum prediction mode in this case is the prediction mode in the upper layer representing the prediction direction closest to the prediction direction of the prediction mode set in the lower layer. If a plurality of prediction mode candidates representing the prediction direction closest to the prediction direction of the lower layer is present in the upper layer, some techniques can be considered to uniquely select the optimum prediction mode.

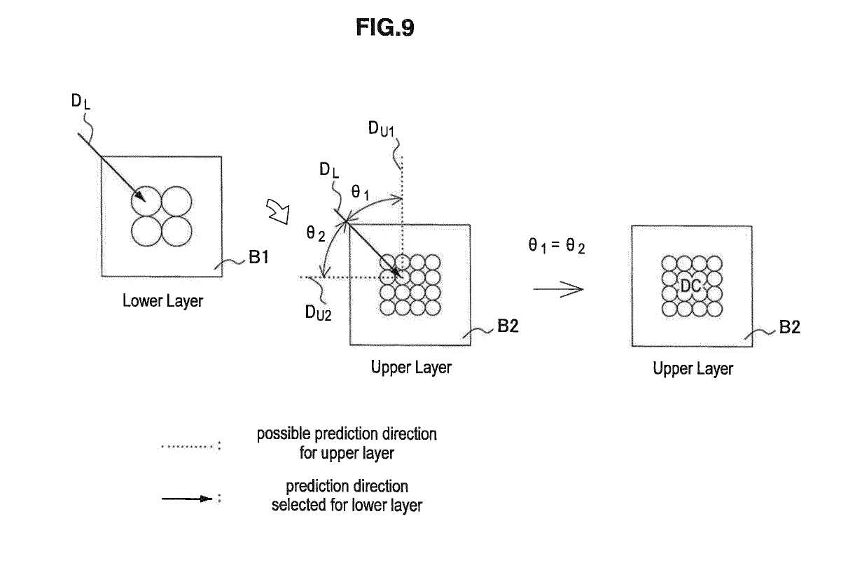

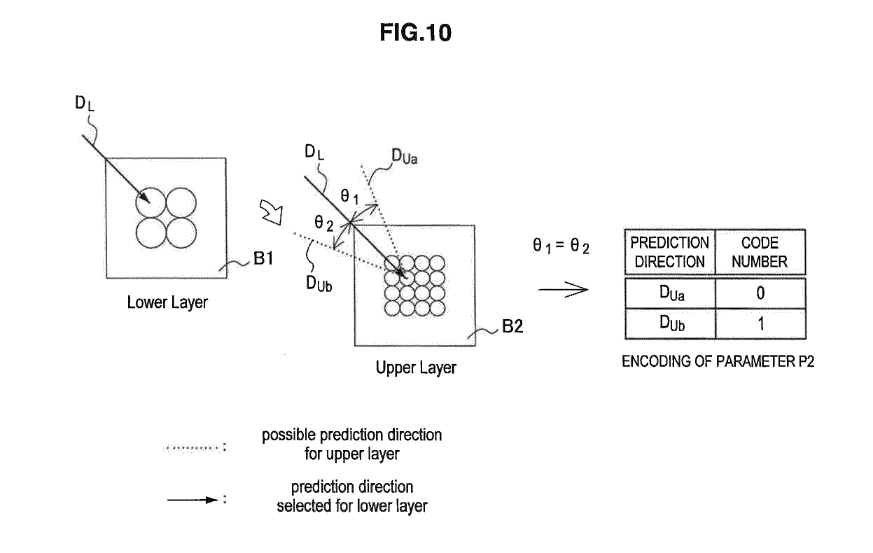

Referring to FIGS. 8 and 9, the prediction unit B1 of the lower layer and the prediction unit B2 of the upper layer corresponding to each other are shown. As an example, the size of the prediction unit B1 is 32×32 pixels and the size of the prediction unit B2 is 64×64 pixels. The prediction direction D, is the prediction direction of the prediction mode set to the prediction unit B1. Prediction direction candidates of the prediction mode that can be set to the prediction unit B2 include the prediction directions D_{U1}, D_{U2}. In the example of FIG. 8, the prediction direction D_{U1} is closer to the prediction direction D_{L} of the lower layer than the prediction direction D_{U2}. Therefore, the mode setting section 41 can set the prediction mode representing the prediction direction D_{U1} to the prediction unit B2. In the example of FIG. 9, on the other hand, the prediction directions D_{U1}, D_{U2} are equidistant from the prediction direction D_{L} of the lower layer. In this case, the mode setting section 41 can set, as a technique, the prediction mode representing the average value (DC) prediction to the prediction unit B2.

When the optimum prediction mode cannot be uniquely selected, instead of selecting the average value prediction like the example in FIG. 9, the mode setting section 41 may select the prediction mode that should be set to a prediction unit of the upper layer according to pre-defined conditions. Pre-defined conditions may be, for example, conditions to rotate the prediction direction in a predetermined rotation direction (clockwise or counterclockwise). In the example of FIG. 9, for example, the prediction direction D_{U1} derived by rotating the prediction direction D_{L} clockwise may be set to the prediction unit B2. Pre-defined conditions may also be, for example, conditions to select the prediction direction in which the code number becomes smaller. By agreeing to conditions to select the prediction mode to be set to the upper layer between the encoding side and the decoding side as described above, scalable-video-coded image data of the upper layer can correctly be decoded without needing special parameters.

The prediction section 42 generates a predicted image of each prediction unit using reference image data input from the frame memory 25 according to the prediction mode set by the mode setting section 41. In this case, the determination of the optimum prediction mode by the mode determination section 43 based on the cost function value is omitted (the cost function value may be calculated). When a still higher layer is present, the mode buffer 44 stores prediction mode information indicating the prediction mode set by the mode setting section 41.

As another technique to uniquely select the optimum prediction mode, the optimum prediction mode may also be estimated when prediction modes are aggregated. In such a modification, when a plurality of prediction mode candidates representing the prediction direction closest to the prediction direction of the lower layer is present in the upper layer, the mode setting section 41 successively sets each of the plurality (normally two) of prediction mode candidates to each prediction unit of the upper layer. The prediction section 42 generates a predicted image of each prediction unit using reference image data input from the frame memory 25 according to each prediction mode candidate set by the mode setting section 41. The mode determination section 43 calculates a cost function value of each prediction mode candidate based on original image data and predicted image data input from the prediction section 42. Then, the mode determination section 43 determines the optimum prediction mode based on the calculated cost function value. When a still higher layer is present, the mode buffer 44 stores prediction mode information indicating the optimum prediction mode decided by the mode determination section 43.

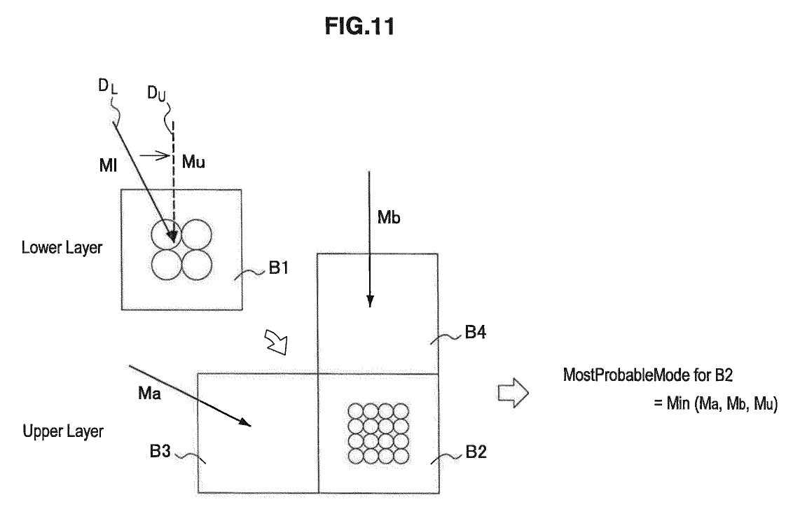

The parameter generation section 45 can generate a parameter P2 as illustrated in FIG. 10 that identifies the optimum prediction mode decided by the mode determination section 43. In the example of FIG. 10, the prediction direction D_{L} is the prediction direction of the prediction mode set to the prediction unit B1 in the lower layer. Prediction direction candidates of the prediction mode that can be set to the prediction unit B2 include prediction directions D_{Ua}, D_{Ub} and do not include the prediction direction D_{L}. The prediction directions D_{Ua}, D_{Ub} are equidistant from the prediction direction D_{L} of the lower layer. In this case, the parameter generation section 45 can generate the 1-bit parameter P2 representing the optimum prediction mode (encoded with the code number “0” or “1”) decided by the mode determination section 43.

In both of extension and aggregation of the prediction direction, parameters generated by the parameter generation section 45 are each encoded by the lossless encoding section 16 as one piece of information about an intra prediction and transmitted to the decoding side in a header region of an encoded stream.

(4) Most Probable Mode

The mode setting section 41 may estimate the optimum prediction mode (prediction direction) for the block to be predicted from the prediction mode (prediction direction) set to the reference block to inhibit an increase in the amount of code due to encoding of prediction mode information. In this case, if the prediction mode estimated by the mode setting section (hereinafter, called the estimated prediction mode) and the optimum prediction mode selected by using a cost function value are equal, only information indicating that the prediction mode can be estimated can be encoded as prediction mode information. Information indicating that the prediction mode can be estimated corresponds to, or example, “Most Probable Mode” in H.264/AVC.

In H.264/AVC, the prediction unit above the prediction unit as a block to be predicted and the prediction unit to the left thereof are used when deciding Most Probable Mode. If the mode number of the estimated prediction mode estimated by Most Probable Mode is Mc and the mode numbers of the left reference block and the upper reference block are Ma and Mb respectively, the mode number Mc of the estimated prediction mode in H.264/AVC is decided as shown below:

Mc=min(Ma,Mb)

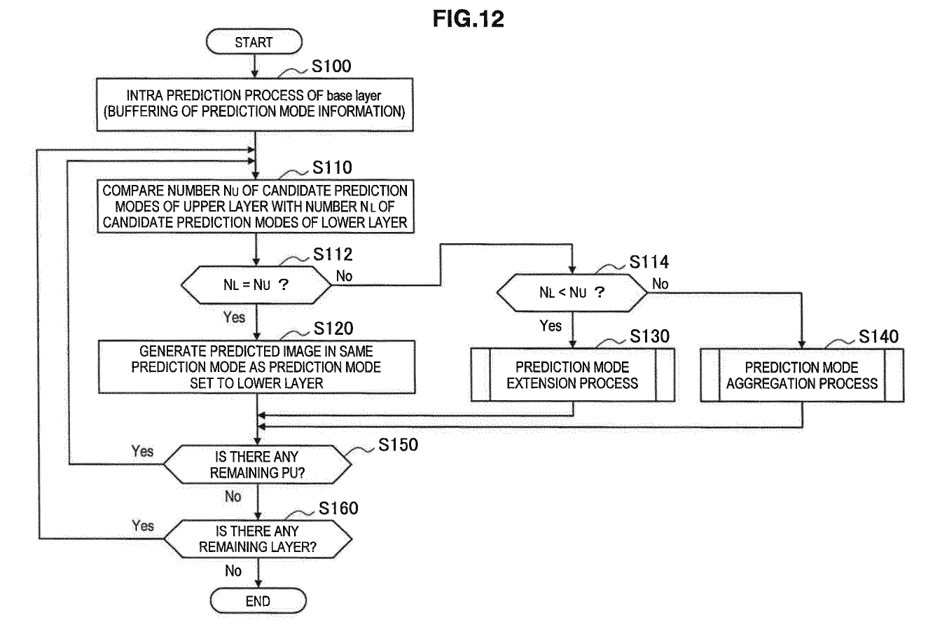

In the present embodiment, by contrast, the mode setting section 41 can refer to, for example, even the prediction unit of the lower layer corresponding to the prediction unit of the upper layer when deciding Most Probable Mode. However, if the prediction unit of the upper layer and the prediction unit as a reference block of the lower layer are different in block size, using the mode number of the prediction mode of the prediction unit in the lower layer as it is not appropriate. Thus, following the way of thinking of the extension and aggregation of the predicted mode described above, the mode setting section 41 decides Most Probable Mode after converting the prediction mode of the prediction unit of the lower layer into a prediction mode among prediction mode candidates of the upper layer. For example, as shown in FIG. 11, a mode number M1 of the prediction mode of the prediction unit in the lower layer is assumed to be converted into a mode number Mu of the prediction mode of the upper layer. The mode setting section 41 can decide the mode number Mc of the estimated prediction mode of the prediction unit of the upper layer as shown below by using the mode numbers Ma, Mb of the prediction modes of the left and upper reference blocks and the mode number Mu of the prediction mode after conversion of the prediction unit of the lower layer:

Mc=min(Ma,Mb,Mu)

Instead of the above formula, other formulas may also be used.

If the estimated prediction mode estimated by Most Probable Mode is the optimum prediction mode, a parameter indicating that the prediction mode can be estimated by the parameter generation section 45 is generated and the generated parameter can be encoded by the lossless encoding section 16.

Therefore, the prediction mode can be estimated with high precision using correlations of images between layers by applying the way of thinking of the extension and aggregation of the prediction mode described above and also referring to the prediction mode of the lower layer when deciding Most Probable Mode.

### 2. Flow of Process at the Time of Encoding According to an Embodiment

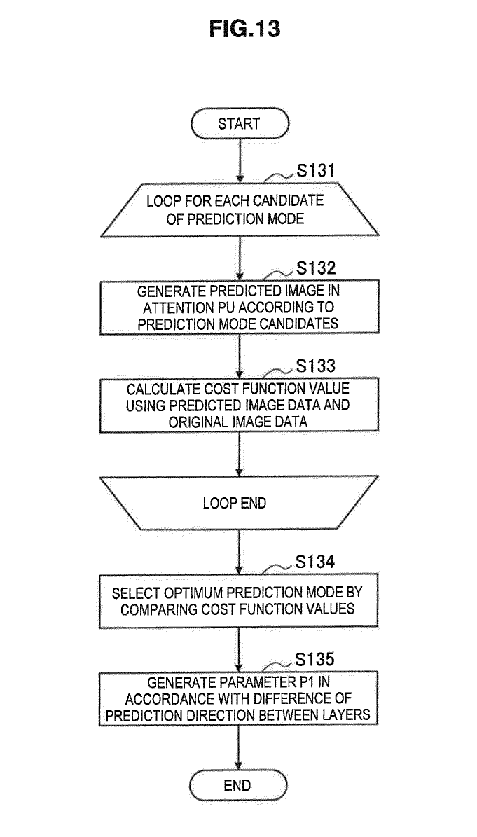

Next, the flow of process at the time of encoding will be described using FIGS. 12 to 14B.

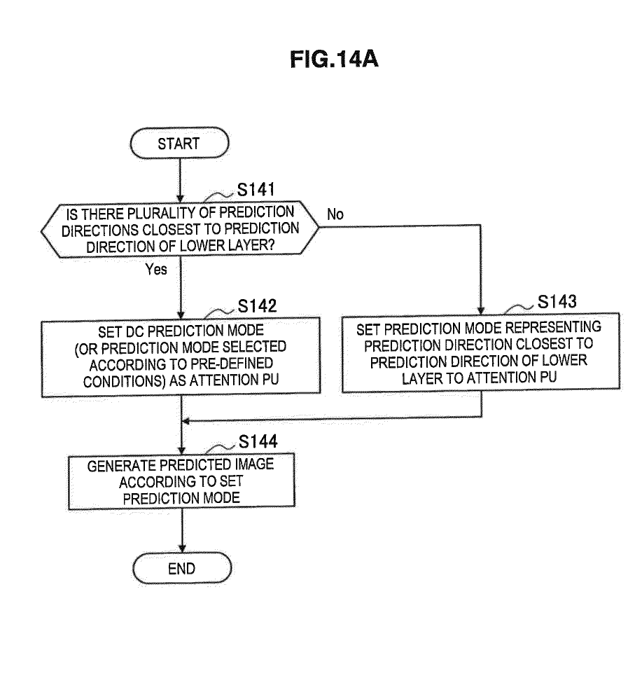

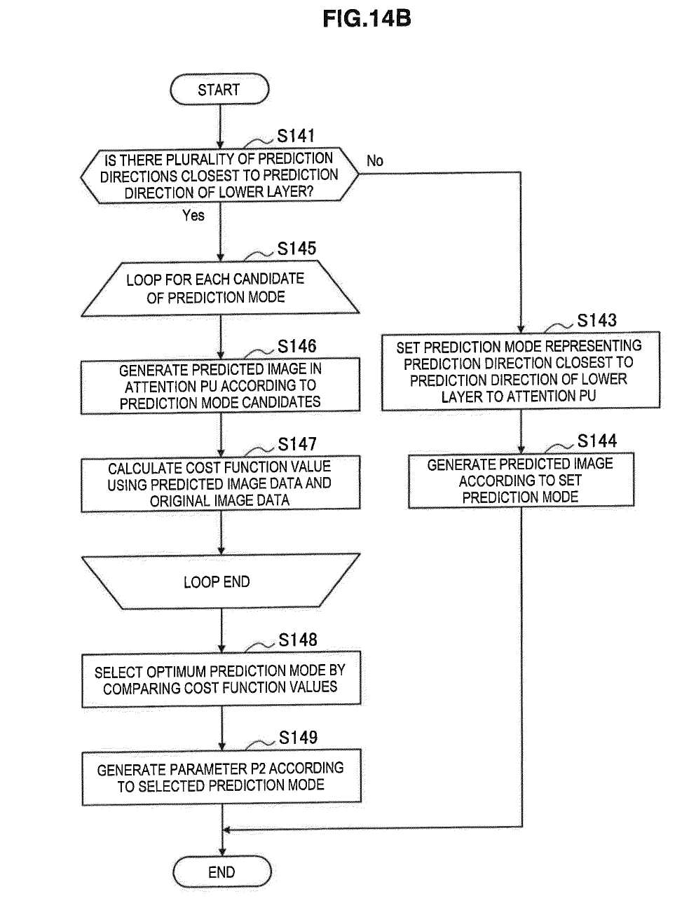

FIG. 12 is a flow chart showing an example of the flow of an intra prediction process by the intra prediction section 40 having the configuration illustrated in FIG. 3. FIG. 13 is a flow chart showing an example of a detailed flow of a prediction mode extension process. FIGS. 14A and 14B are flow charts showing a first example and a second example of the detailed flow of a prediction mode aggregation process respectively.

Referring to FIG. 12, the intra prediction section 40 first performs an intra prediction process of the base layer (step S100). As a result, the arrangement of prediction units in each coding unit is decided and the optimum prediction mode in the lower layer is set to each prediction unit. The mode buffer 44 buffers prediction mode information representing the optimum prediction mode of each prediction unit.

Processes in steps S110 to S160 are intra prediction processes of enhancement layers. Of these processes, processes in steps S100 to S150 are repeated for each block (each prediction unit) of each enhancement layer. In the description that follows, the “upper layer” is a layer to be predicted and the “lower layer” is a lower layer of the layer to be predicted.

First, the mode setting section 41 identifies a number N_{U} of candidate prediction modes of an attention PU of the upper layer and a number N_{L} of candidate prediction modes of the corresponding PU of the lower layer from the block size of each PU and compares the numbers N_{U}, N_{L} of candidate prediction modes (step S110). If, for example, N_{L}=N_{U}, the process proceeds to step S120 (step S112). If N_{L}<N_{U}, the process proceeds to step S130 (step S114). If N_{L}>N_{U}, the process proceeds to step S140.

In step S120, the mode setting section 41 sets the same prediction mode as the prediction mode set to the corresponding PU of the lower layer to the attention PU (that is, the prediction mode is reused). Then, the prediction section 42 generates a predicted image of the attention PU according to the set prediction mode (step S120).

In step S130, on the other hand, the prediction mode extension process illustrated in FIG. 13 is performed. In step S140, the prediction mode aggregation process illustrated in FIGS. 14A and 14B is performed.

In the prediction mode extension process in FIG. 13, processes in step S132 and step S133 are repeated for each candidate of the prediction mode of the upper layer (step S131). First, a predicted image of the attention PU is generated by the prediction section 42 according to the prediction mode candidate set to the attention PU by the mode setting section 41 (step S132). Then, a cost function value is calculated by the mode determination section 43 using predicted image data and original image data (step S133). When the loop ends, the mode determination section 43 selects the optimum prediction mode by comparing cost function values calculated for a plurality of prediction mode candidates (step S134). Then, the parameter generation section 45 generates the parameter P1 in accordance with a difference of the prediction direction between layers to identify the selected optimum prediction mode (step S135).

In the first example of the prediction mode aggregation process in FIG. 14A, the mode setting section 41 first determines whether a plurality of prediction directions closest to the prediction direction of the corresponding PU of the lower layer is present in prediction direction candidates of the upper layer (step S141). If the plurality of prediction directions closest to the prediction direction of the corresponding PU is present, the mode setting section 41 sets the average value (DC) prediction mode or a prediction mode selected according to pre-defined conditions as the attention PU (step S142). On the other hand, if only one prediction direction closest to the prediction direction of the corresponding PU is present, the mode setting section 41 sets the prediction mode representing the one prediction direction as the attention PU (step S143). Then, the prediction section 42 generates a predicted image of the attention PU according to the set prediction mode (step S144).

In the second example of the prediction mode aggregation process in FIG. 14B, the mode setting section 41 first determines whether a plurality of prediction directions closest to the prediction direction of the corresponding PU of the lower layer is present in prediction direction candidates of the upper layer (step S141). The process performed when only one prediction direction closest to the prediction direction of the corresponding PU is present is the same as in the first example in FIG. 14A (steps S143, S144). On the other hand, if a plurality of prediction directions closest to the prediction direction of the corresponding PU is present, processes in steps S146 and S147 are repeated for each of the plurality of prediction directions (step S145). First, a predicted image of the attention PU is generated by the prediction section 42 according to the prediction mode candidate representing each prediction direction (step S146). Then, a cost function value is calculated by the mode determination section 43 using predicted image data and original image data (step S147). When the loop ends, the mode determination section 43 selects the optimum prediction mode by comparing cost function values calculated for a plurality of prediction mode candidates (step S148). Then, the parameter generation section 45 generates the parameter P2 to identify the selected optimum prediction mode (step S149).

Returning to FIG. 12, the description of the flow of the intra prediction process of enhancement layers by the intra prediction section 40 will continue.

After the prediction mode is set to the attention PU in step S120, S130, or S140 and a predicted image is generated, the process returns to step S110 if any PU that is not yet processed remains in the layer to be predicted (step S150). On the other hand, if no PU that is not yet processed remains in the layer to be predicted, whether any remaining layer (higher layer) is present is determined (step S160) and a remaining layer is present, the processes in step S110 and thereafter are repeated by setting the layer that has been predicted as the lower layer and the next layer as the upper layer. Prediction mode information is buffered by the mode buffer 44. If no remaining layer is present, the intra prediction process in FIG. 12 ends. Predicted image data generated here and information about the inter prediction (that may include the parameters P1, P2) are output to each of the subtraction section 13 and the lossless encoding section 16 from the mode determination section 43 via the selector 27.

### 3. Example Configuration of Image Decoding Device According to an Embodiment

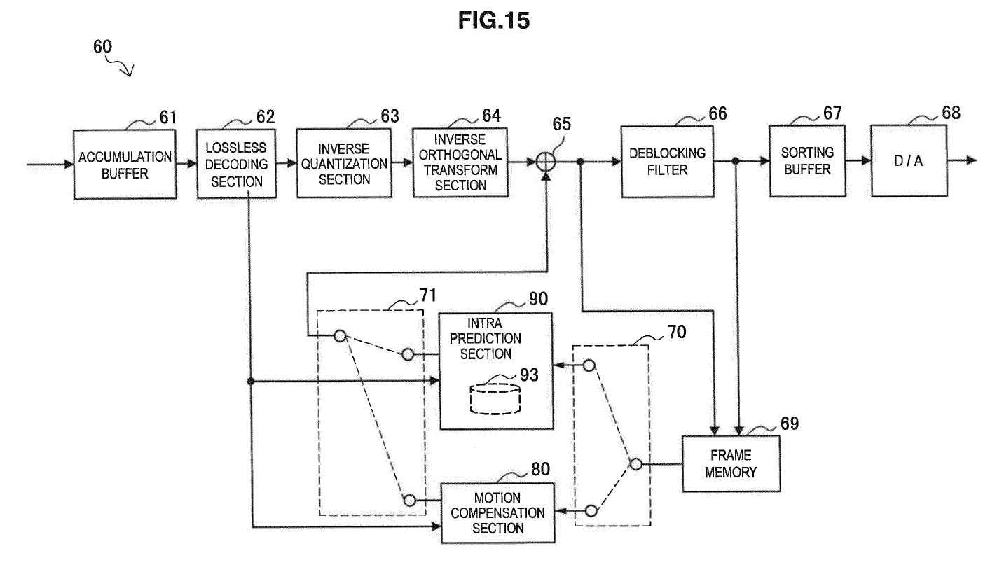

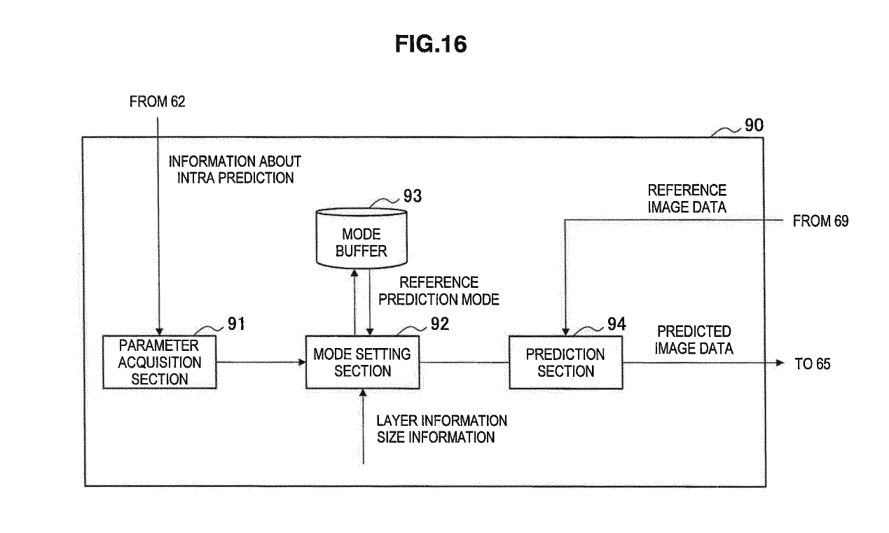

In this section, an example configuration of an image decoding device according to an embodiment will be described using FIGS. 15 and 16.

[3-1. Example of Overall Configuration]

FIG. 15 is a block diagram showing an example of a configuration of an image decoding device 60 according to an embodiment. Referring to FIG. 15, the image decoding device 60 includes an accumulation buffer 61, a lossless decoding section 62, an inverse quantization section 63, an inverse orthogonal transform section 64, an addition section 65, a deblocking filter 66, a sorting buffer 67, a D/A (Digital to Analogue) conversion section 68, a frame memory 69, selectors 70 and 71, a motion compensation section 80 and an intra prediction section 90.

The accumulation buffer 61 temporarily stores an encoded stream input via a transmission line using a storage medium.

The lossless decoding section 62 decodes an encoded stream input from the accumulation buffer 61 according to the encoding method used at the time of encoding. Also, the lossless decoding section 62 decodes information multiplexed to the header region of the encoded stream. Information that is multiplexed to the header region of the encoded stream may include information about inter prediction and information about intra prediction described above, for example. The lossless decoding section 62 outputs the information about inter prediction to the motion compensation section 80. Also, the lossless decoding section 62 outputs the information about intra prediction to the intra prediction section 90.

The inverse quantization section 63 inversely quantizes quantized data which has been decoded by the lossless decoding section 62. The inverse orthogonal transform section 64 generates predicted error data by performing inverse orthogonal transformation on transform coefficient data input from the inverse quantization section 63 according to the orthogonal transformation method used at the time of encoding. Then, the inverse orthogonal transform section 64 outputs the generated predicted error data to the addition section 65.

The addition section 65 adds the predicted error data input from the inverse orthogonal transform section 64 and predicted image data input from the selector 71 to thereby generate decoded image data. Then, the addition section 65 outputs the generated decoded image data to the deblocking filter 66 and the frame memory 69.

The deblocking filter 66 removes block distortion by filtering the decoded image data input from the addition section 65, and outputs the decoded image data after filtering to the sorting buffer 67 and the frame memory 69.

The sorting buffer 67 generates a series of image data in a time sequence by sorting images input from the deblocking filter 66. Then, the sorting buffer 67 outputs the generated image data to the D/A conversion section 68.

The D/A conversion section 68 converts the image data in a digital format input from the sorting buffer 67 into an image signal in an analogue format. Then, the D/A conversion section 68 causes an image to be displayed by outputting the analogue image signal to a display (not shown) connected to the image decoding device 60, for example.

The frame memory 69 stores, using a storage medium, the decoded image data before filtering input from the addition section 65, and the decoded image data after filtering input from the deblocking filter 66.

The selector 70 switches the output destination of the image data from the frame memory 69 between the motion compensation section 80 and the intra prediction section 90 for each block in the image according to mode information acquired by the lossless decoding section 62. For example, in the case the inter prediction mode is specified, the selector 70 outputs the decoded image data after filtering that is supplied from the frame memory 69 to the motion compensation section 80 as the reference image data. Also, in the case the intra prediction mode is specified, the selector 70 outputs the decoded image data before filtering that is supplied from the frame memory 69 to the intra prediction section 90 as reference image data.

The selector 71 switches the output source of predicted image data to be supplied to the addition section 65 between the motion compensation section 80 and the intra prediction section 90 according to the mode information acquired by the lossless decoding section 62. For example, in the case the inter prediction mode is specified, the selector 71 supplies to the addition section 65 the predicted image data output from the motion compensation section 80. Also, in the case the intra prediction mode is specified, the selector 71 supplies to the addition section 65 the predicted image data output from the intra prediction section 90.

The motion compensation section 80 performs a motion compensation process based on the information about inter prediction input from the lossless decoding section 62 and the reference image data from the frame memory 69, and generates predicted image data. Then, the motion compensation section 80 outputs the generated predicted image data to the selector 71.

The intra prediction section 90 performs an intra prediction process based on information about intra predictions input from the lossless decoding section 62 and reference image data from the frame memory 69 and generates predicted image data. The number of prediction mode candidates that can be selected by the intra prediction section 90 is different depending on the block size of the prediction unit. When, for example, the aforementioned angular intra prediction method is adopted, the number of prediction mode candidates by block size is as shown in Table 1 described above. Then, the intra prediction section 90 outputs generated predicted image data to the selector 71. The intra prediction process by the intra prediction section 90 described above will be described in detail later.

The image decoding device 60 repeats a series of decoding processes described here for each of a plurality of layers of a scalable-video-coded image. The layer to be decoded first is the base layer. After the base layer is decoded, one or more enhancement layers are decoded. When an enhancement layer is decoded, information obtained by decoding the base layer or lower layers as other enhancement layers is used.

For scalable video decoding by the image decoding device 60, the prediction mode of an upper layer is predicted based on a prediction mode of a lower layer for each prediction unit. The prediction of the prediction mode may include the reuse of the prediction mode, extension of the prediction mode, and aggregation of the prediction mode. A mode buffer 93 of the intra prediction section 90 shown in FIG. 15 is provided to temporarily store prediction mode information of lower layers for predicting the prediction mode.

[3-2. Configuration Example of Intra Prediction Section]

FIG. 16 is a block diagram showing an example of a detailed configuration of the intra prediction section 90 of the image decoding device 60 shown in FIG. 15. Referring to FIG. 16, the intra prediction section 90 includes a parameter acquisition section 91, a mode setting section 92, a mode buffer 93, and a prediction section 94.

In an intra prediction process of the base layer, the parameter acquisition section 91 acquires information about an intra prediction decoded by the lossless decoding section 62. Information about the intra prediction of the base layer may contain, for example, information identifying the arrangement of prediction units in each coding unit and prediction mode information of each prediction unit. The mode setting section 92 arranges prediction units in each coding unit and further sets the prediction mode to each prediction unit based on information acquired by the parameter acquisition section 91. The mode buffer 93 temporarily stores prediction mode information indicating the prediction mode set to each prediction unit. The prediction section 94 generates a predicted image of each prediction unit using reference image data input from the frame memory 69 according to the prediction mode set by the mode setting section 92. Then, the prediction section 94 outputs predicted image data to the addition section 65.

Intra prediction processes of enhancement layers can mainly be divided into three types of the reuse of the prediction direction, extension of the prediction direction, and aggregation of the prediction direction.

(1) Reuse of the Prediction Direction

When the number of prediction mode candidates of the lower layer is equal to the number of prediction mode candidates of the upper layer in an intra prediction process of an enhancement layer, no additional parameter is acquired. The mode setting section 92 reuses the prediction mode indicated by prediction mode information stored in the mode buffer 93. That is, in this case, the mode setting section 92 sets the same prediction mode as the prediction mode set to the corresponding prediction unit of the lower layer to each prediction unit of the upper layer. The prediction section 94 generates a predicted image of each prediction unit according to the prediction mode set by the mode setting section 92. When a still higher layer is present, the mode buffer 93 stores prediction mode information indicating the prediction mode set by the mode setting section 92.

(2) Extension of the Prediction Direction

When the number of prediction mode candidates of the lower layer is smaller than the number of prediction mode candidates of the upper layer, the parameter acquisition section 91 acquires the aforementioned parameter P1 encoded in accordance with a difference of the prediction direction between the prediction unit of the upper layer and the corresponding prediction unit of the lower layer. The parameter P1 is a parameter encoded with a smaller code number with a decreasing absolute value of a difference of the prediction directions. If, for example, the code word corresponding to the parameter P1 is the shortest code word, the code word is mapped to the code number “0” by the lossless decoding section 62 shown in FIG. 15. Then, according to the code number table illustrated in FIG. 6, FIG. 7A, or FIG. 7B, the code number “0” is interpreted to indicate that the difference of prediction directions is zero. In this case, the mode setting section 92 can set the prediction mode representing the same prediction direction as the prediction mode set to the corresponding prediction unit of the lower layer to the prediction unit of the upper layer. On the other hand, when the code number of the parameter P1 is equal to “1” or more, the mode setting section 92 can set the prediction mode representing the prediction direction selected according to a difference of the prediction direction corresponding to the code number to the prediction unit of the upper layer. In this case, being positive or negative as a difference of the prediction direction may be interpreted, as described using FIGS. 7A and 7B, in accordance with the aspect ratio of a decoded image. The prediction section 94 generates a predicted image of each prediction unit according to the prediction mode set by the mode setting section 92. When a still higher layer is present, the mode buffer 93 stores prediction mode information indicating the prediction mode set by the mode setting section 92.

(3) Aggregation of the Prediction Direction

When the number of prediction mode candidates of the lower layer is larger than the number of prediction mode candidates of the upper layer, the parameter acquisition section 91 may acquire the additional parameter P2 or may not acquire the additional parameter.

When the additional parameter is not acquired, the mode setting section 92 sets the prediction mode selected based on only the prediction mode set to the corresponding prediction unit of the lower layer to the prediction unit of the upper layer. Typically, the prediction mode set to the prediction unit of the upper layer is a prediction mode representing the prediction direction closest to the prediction direction of the corresponding prediction unit of the lower layer. When a plurality of prediction modes representing the prediction direction closest to the prediction direction of the lower layer is present, the mode setting section 92 may set the prediction mode representing the average value prediction to the prediction unit of the upper layer. Such a technique is adopted when, for example, the block size of the upper layer is 64×64 pixels. Instead, the mode setting section 92 may select the prediction mode to be set to the prediction unit of the upper layer according to pre-defined conditions. Pre-defined conditions may be, for example, conditions to rotate the prediction direction in a predetermined rotation direction or conditions to select a smaller code number.

On the other hand, when the aforementioned parameter P2 to select the prediction mode is encoded, the parameter acquisition section 91 acquires the parameter P2. In this case, the mode setting section 92 sets the prediction mode specified by the parameter P2 of two prediction modes representing the prediction direction closest to the prediction direction of the prediction mode set to the corresponding prediction unit of the lower layer to the prediction unit.

In both cases, like the prediction direction extension process, the prediction section 94 generates a predicted image of each prediction unit according to the prediction mode set by the mode setting section 92. When a still higher layer is present, the mode buffer 93 stores prediction mode information indicating the prediction mode set by the mode setting section 92.

(4) Most Probable Mode

When information indicating that the prediction mode can be estimated for a certain prediction unit is contained in information about an intra prediction, the mode setting section 92 may set the prediction mode estimated by Most Probable Mode described above to the relevant prediction unit. In the estimation of the prediction mode in the present embodiment, Most Probable Mode is decided based on not only left and upper reference blocks, but also the prediction mode set to the corresponding prediction unit of the lower layer. Thus, following the way of thinking of the extension and aggregation of the predicted mode described above, the mode setting section 92 decides Most Probable Mode after converting the prediction mode of the prediction unit of the lower layer into a prediction mode among prediction mode candidates of the upper layer. For example, the mode number Mc of the estimated prediction mode of a certain prediction unit can be decided as shown below by using the mode numbers Ma, Mb of the prediction modes of the left and upper reference blocks and the mode number Mu of the prediction mode after conversion of the prediction unit of the lower layer:

Mc=min(Ma,Mb,Mu)

Instead of the above formula, other formulas may also be used.

### 4. Flow of Process at the Time of Decoding According to an Embodiment

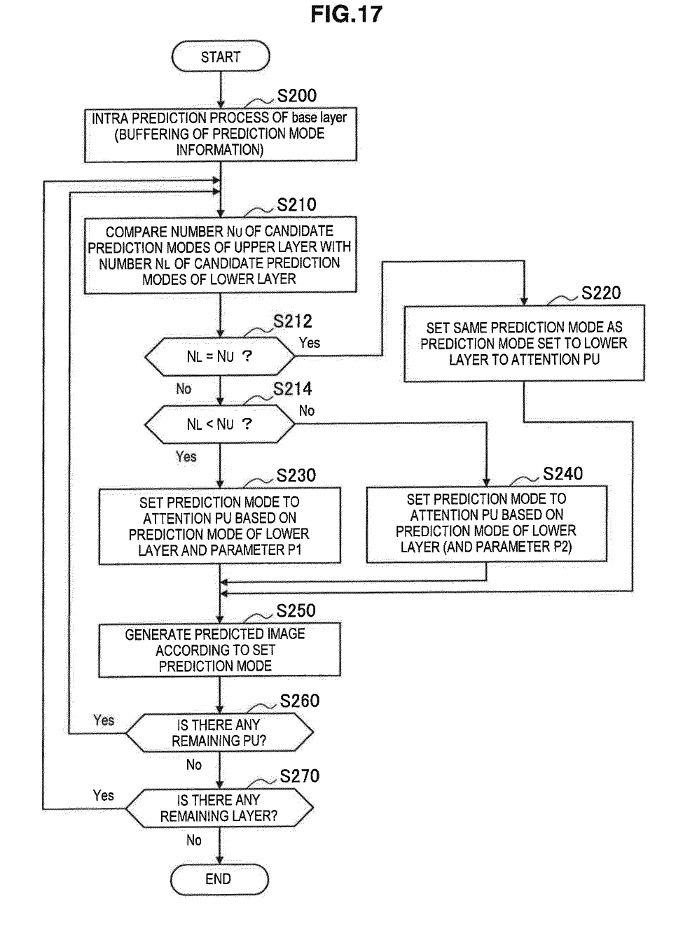

Next, the flow of process at the time of decoding will be described using FIG. 17. FIG. 17 is a flow chart showing an example of the flow of an intra prediction process by the intra prediction section 90 having the configuration illustrated in FIG. 16.

Referring to FIG. 17, the intra prediction section 90 first performs an intra prediction process of the base layer (step S200). As a result, a predicted image of the base layer is generated and also prediction mode information indicating the prediction mode set to each prediction unit is buffered by the mode buffer 93.

Processes in steps S210 to S270 are intra prediction processes of enhancement layers. Of these processes, processes in steps S210 to S260 are repeated for each block (each prediction unit) of each enhancement layer. In the description that follows, the “upper layer” is a layer to be predicted and the “lower layer” is a lower layer of the layer to be predicted.

First, the mode setting section 92 identifies the number N_{U} of candidate prediction modes of an attention PU of the upper layer and the number N_{L} of candidate prediction modes of the corresponding PU of the lower layer from the block size of each PU and compares the numbers N_{U}, N_{L} of candidate prediction modes (step S210). If, for example, N_{L}=N_{U}, the process proceeds to step S220 (step S212). If N_{L}<N_{U}, the process proceeds to step S230 (step S214). If N_{L}>N_{U}, the process proceeds to step S240.

In step S220, the mode setting section 92 sets the same prediction mode as the prediction mode set to the corresponding PU of the lower layer to the attention PU (that is, the prediction mode is reused) (step S220).

In step S230, the mode setting section 92 sets the prediction mode selected based on the prediction mode set to the corresponding PU of the lower layer and the parameter P1 acquired by the parameter acquisition section 91 to the attention PU (step S230).

In step S240, the mode setting section 92 sets the prediction mode selected based on the prediction mode set to the corresponding PU of the lower layer and, if the parameter P2 is encoded, the parameter P2 to the attention PU (step S240).

Then, the prediction section 94 generates a predicted image of the attention PU using reference image data input from the frame memory 69 according to the prediction mode set by the mode setting section 92 (step S250).

If, after the predicted image of the attention PU is generated, any PU that is not yet processed remains in the layer to be predicted, the process returns to step S210 (step S260). On the other hand, if no PU that is not yet processed remains in the layer to be predicted, whether any remaining layer (higher layer) is present is determined (step S270) and a remaining layer is present, the processes in step S210 and thereafter are repeated by setting the layer that has been predicted as the lower layer and the next layer as the upper layer. Prediction mode information is buffered by the mode buffer 93. If no remaining layer is present, the intra prediction process in FIG. 17 ends. Predicted image data generated here is output to the addition section 65 via the selector 71.

### 5. Example Application

The image encoding device 10 and the image decoding device 60 according to the embodiment described above may be applied to various electronic appliances such as a transmitter and a receiver for satellite broadcasting, cable broadcasting such as cable TV, distribution on the Internet, distribution to terminals via cellular communication, and the like, a recording device that records images in a medium such as an optical disc, a magnetic disk or a flash memory, a reproduction device that reproduces images from such storage medium, and the like. Four example applications will be described below.

### 5-1. First Application Example

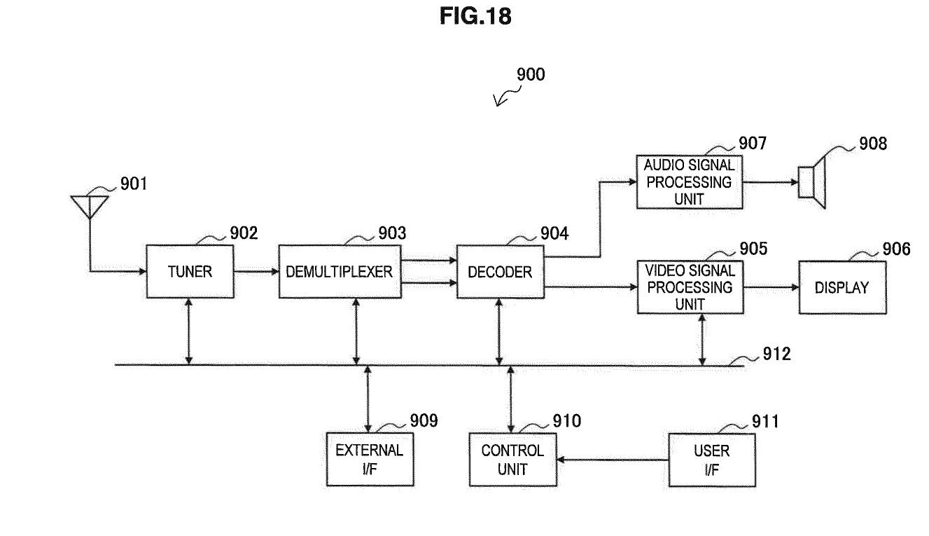

FIG. 18 is a diagram illustrating an example of a schematic configuration of a television device applying the aforementioned embodiment. A television device 900 includes an antenna 901, a tuner 902, a demultiplexer 903, a decoder 904, a video signal processing unit 905, a display 906, an audio signal processing unit 907, a speaker 908, an external interface 909, a control unit 910, a user interface 911, and a bus 912.

The tuner 902 extracts a signal of a desired channel from a broadcast signal received through the antenna 901 and demodulates the extracted signal. The tuner 902 then outputs an encoded bit stream obtained by the demodulation to the demultiplexer 903. That is, the tuner 902 has a role as transmission means receiving the encoded stream in which an image is encoded, in the television device 900.

The demultiplexer 903 isolates a video stream and an audio stream in a program to be viewed from the encoded bit stream and outputs each of the isolated streams to the decoder 904. The demultiplexer 903 also extracts auxiliary data such as an EPG (Electronic Program Guide) from the encoded bit stream and supplies the extracted data to the control unit 910. Here, the demultiplexer 903 may descramble the encoded bit stream when it is scrambled.

The decoder 904 decodes the video stream and the audio stream that are input from the demultiplexer 903. The decoder 904 then outputs video data generated by the decoding process to the video signal processing unit 905. Furthermore, the decoder 904 outputs audio data generated by the decoding process to the audio signal processing unit 907.

The video signal processing unit 905 reproduces the video data input from the decoder 904 and displays the video on the display 906. The video signal processing unit 905 may also display an application screen supplied through the network on the display 906. The video signal processing unit 905 may further perform an additional process such as noise reduction on the video data according to the setting. Furthermore, the video signal processing unit 905 may generate an image of a GUI (Graphical User Interface) such as a menu, a button, or a cursor and superpose the generated image onto the output image.

The display 906 is driven by a drive signal supplied from the video signal processing unit 905 and displays video or an image on a video screen of a display device (such as a liquid crystal display, a plasma display, or an OELD (Organic ElectroLuminescence Display)).

The audio signal processing unit 907 performs a reproducing process such as D/A conversion and amplification on the audio data input from the decoder 904 and outputs the audio from the speaker 908. The audio signal processing unit 907 may also perform an additional process such as noise reduction on the audio data.

The external interface 909 is an interface that connects the television device 900 with an external device or a network. For example, the decoder 904 may decode a video stream or an audio stream received through the external interface 909. This means that the external interface 909 also has a role as the transmission means receiving the encoded stream in which an image is encoded, in the television device 900.

The control unit 910 includes a processor such as a CPU and a memory such as a RAM and a ROM. The memory stores a program executed by the CPU, program data, EPG data, and data acquired through the network. The program stored in the memory is read by the CPU at the start-up of the television device 900 and executed, for example. By executing the program, the CPU controls the operation of the television device 900 in accordance with an operation signal that is input from the user interface 911, for example.

The user interface 911 is connected to the control unit 910. The user interface 911 includes a button and a switch for a user to operate the television device 900 as well as a reception part which receives a remote control signal, for example. The user interface 911 detects a user operation through these components, generates the operation signal, and outputs the generated operation signal to the control unit 910.

The bus 912 mutually connects the tuner 902, the demultiplexer 903, the decoder 904, the video signal processing unit 905, the audio signal processing unit 907, the external interface 909, and the control unit 910.

The decoder 904 in the television device 900 configured in the aforementioned manner has a function of the image decoding device 60 according to the aforementioned embodiment. Accordingly, for scalable video decoding of images by the television device 900, image data of enhancement layers encoded can be decoded more efficiently.

### 5-2. Second Application Example

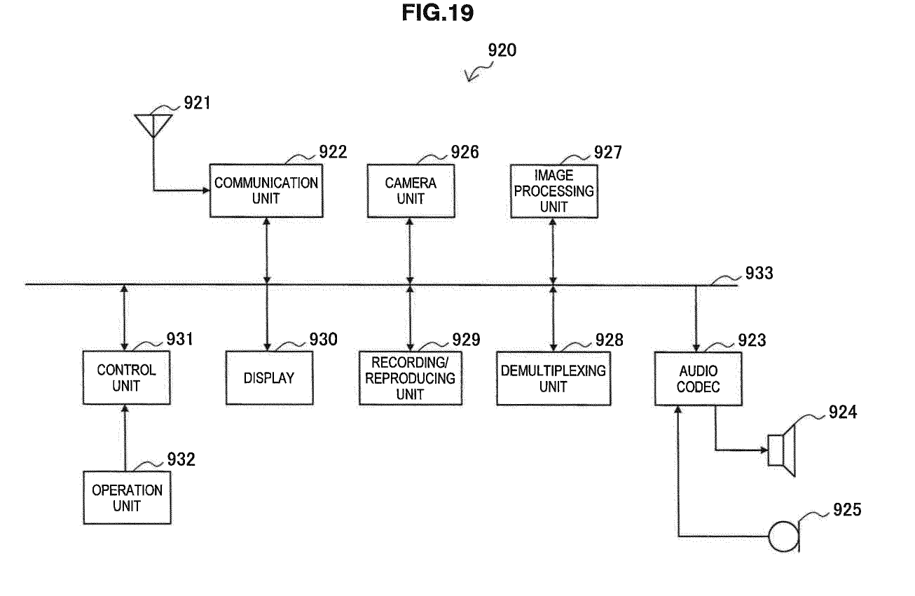

FIG. 19 is a diagram illustrating an example of a schematic configuration of a mobile telephone applying the aforementioned embodiment. A mobile telephone 920 includes an antenna 921, a communication unit 922, an audio codec 923, a speaker 924, a microphone 925, a camera unit 926, an image processing unit 927, a demultiplexing unit 928, a recording/reproducing unit 929, a display 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 mutually connects the communication unit 922, the audio codec 923, the camera unit 926, the image processing unit 927, the demultiplexing unit 928, the recording/reproducing unit 929, the display 930, and the control unit 931.

The mobile telephone 920 performs an operation such as transmitting/receiving an audio signal, transmitting/receiving an electronic mail or image data, imaging an image, or recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A/D conversion on the converted audio data, and compresses the data. The audio codec 923 thereafter outputs the compressed audio data to the communication unit 922. The communication unit 922 encodes and modulates the audio data to generate a transmission signal. The communication unit 922 then transmits the generated transmission signal to a base station (not shown) through the antenna 921. Furthermore, the communication unit 922 amplifies a radio signal received through the antenna 921, converts a frequency of the signal, and acquires a reception signal. The communication unit 922 thereafter demodulates and decodes the reception signal to generate the audio data and output the generated audio data to the audio codec 923. The audio codec 923 expands the audio data, performs D/A conversion on the data, and generates the analog audio signal. The audio codec 923 then outputs the audio by supplying the generated audio signal to the speaker 924.

In the data communication mode, for example, the control unit 931 generates character data configuring an electronic mail, in accordance with a user operation through the operation unit 932. The control unit 931 further displays a character on the display 930. Moreover, the control unit 931 generates electronic mail data in accordance with a transmission instruction from a user through the operation unit 932 and outputs the generated electronic mail data to the communication unit 922. The communication unit 922 encodes and modulates the electronic mail data to generate a transmission signal. Then, the communication unit 922 transmits the generated transmission signal to the base station (not shown) through the antenna 921. The communication unit 922 further amplifies a radio signal received through the antenna 921, converts a frequency of the signal, and acquires a reception signal. The communication unit 922 thereafter demodulates and decodes the reception signal, restores the electronic mail data, and outputs the restored electronic mail data to the control unit 931. The control unit 931 displays the content of the electronic mail on the display 930 as well as stores the electronic mail data in a storage medium of the recording/reproducing unit 929.

The recording/reproducing unit 929 includes an arbitrary storage medium that is readable and writable. For example, the storage medium may be a built-in storage medium such as a RAM or a flash memory, or may be an externally-mounted storage medium such as a hard disk, a magnetic disk, a magneto-optical disk, an optical disk, a USB (Unallocated Space Bitmap) memory, or a memory card.

In the photography mode, for example, the camera unit 926 images an object, generates image data, and outputs the generated image data to the image processing unit 927. The image processing unit 927 encodes the image data input from the camera unit 926 and stores an encoded stream in the storage medium of the storing/reproducing unit 929.

In the videophone mode, for example, the demultiplexing unit 928 multiplexes a video stream encoded by the image processing unit 927 and an audio stream input from the audio codec 923, and outputs the multiplexed stream to the communication unit 922. The communication unit 922 encodes and modulates the stream to generate a transmission signal. The communication unit 922 subsequently transmits the generated transmission signal to the base station (not shown) through the antenna 921. Moreover, the communication unit 922 amplifies a radio signal received through the antenna 921, converts a frequency of the signal, and acquires a reception signal. The transmission signal and the reception signal can include an encoded bit stream. Then, the communication unit 922 demodulates and decodes the reception signal to restore the stream, and outputs the restored stream to the demultiplexing unit 928. The demultiplexing unit 928 isolates the video stream and the audio stream from the input stream and outputs the video stream and the audio stream to the image processing unit 927 and the audio codec 923, respectively. The image processing unit 927 decodes the video stream to generate video data. The video data is then supplied to the display 930, which displays a series of images. The audio codec 923 expands and performs D/A conversion on the audio stream to generate an analog audio signal. The audio codec 923 then supplies the generated audio signal to the speaker 924 to output the audio.

The image processing unit 927 in the mobile telephone 920 configured in the aforementioned manner has a function of the image encoding device 10 and the image decoding device 60 according to the aforementioned embodiment. Accordingly, for scalable video coding and decoding of images by the mobile telephone 920, image data of enhancement layers can be encoded and decoded more efficiently.

### 5-3. Third Application Example

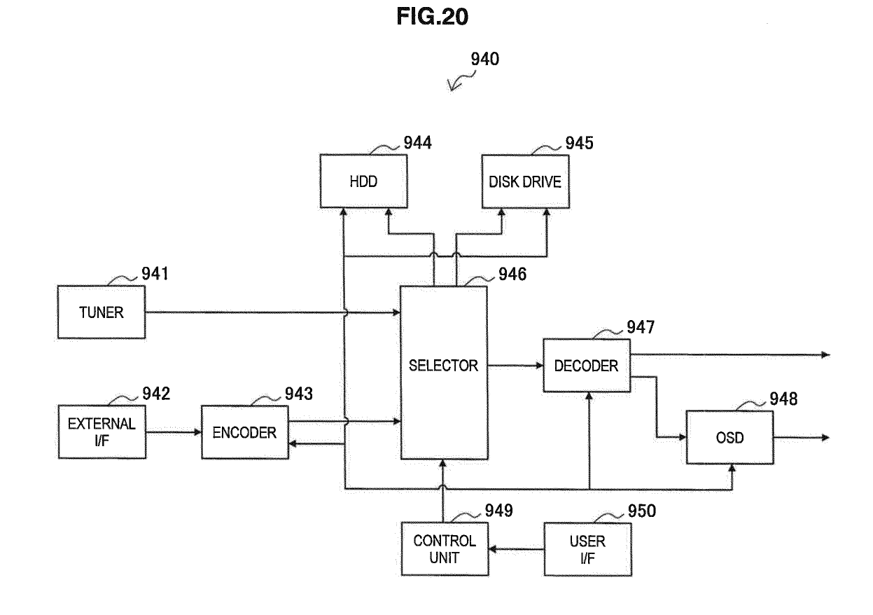

FIG. 20 is a diagram illustrating an example of a schematic configuration of a recording/reproducing device applying the aforementioned embodiment. A recording/reproducing device 940 encodes audio data and video data of a broadcast program received and records the data into a recording medium, for example. The recording/reproducing device 940 may also encode audio data and video data acquired from another device and record the data into the recording medium, for example. In response to a user instruction, for example, the recording/reproducing device 940 reproduces the data recorded in the recording medium on a monitor and a speaker. The recording/reproducing device 940 at this time decodes the audio data and the video data.

The recording/reproducing device 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from a broadcast signal received through an antenna (not shown) and demodulates the extracted signal. The tuner 941 then outputs an encoded bit stream obtained by the demodulation to the selector 946. That is, the tuner 941 has a role as transmission means in the recording/reproducing device 940.

The external interface 942 is an interface which connects the recording/reproducing device 940 with an external device or a network. The external interface 942 may be, for example, an IEEE 1394 interface, a network interface, a USB interface, or a flash memory interface. The video data and the audio data received through the external interface 942 are input to the encoder 943, for example. That is, the external interface 942 has a role as transmission means in the recording/reproducing device 940.

The encoder 943 encodes the video data and the audio data when the video data and the audio data input from the external interface 942 are not encoded. The encoder 943 thereafter outputs an encoded bit stream to the selector 946.

The HDD 944 records, into an internal hard disk, the encoded bit stream in which content data such as video and audio is compressed, various programs, and other data. The HDD 944 reads these data from the hard disk when reproducing the video and the audio.

The disk drive 945 records and reads data into/from a recording medium which is mounted to the disk drive. The recording medium mounted to the disk drive 945 may be, for example, a DVD disk (such as DVD-Video, DVD-RAM, DVD-R, DVD-RW, DVD+R, or DVD+RW) or a Blu-ray (Registered Trademark) disk.

The selector 946 selects the encoded bit stream input from the tuner 941 or the encoder 943 when recording the video and audio, and outputs the selected encoded bit stream to the HDD 944 or the disk drive 945. When reproducing the video and audio, on the other hand, the selector 946 outputs the encoded bit stream input from the HDD 944 or the disk drive 945 to the decoder 947.

The decoder 947 decodes the encoded bit stream to generate the video data and the audio data. The decoder 904 then outputs the generated video data to the OSD 948 and the generated audio data to an external speaker.

The OSD 948 reproduces the video data input from the decoder 947 and displays the video. The OSD 948 may also superpose an image of a GUI such as a menu, a button, or a cursor onto the video displayed.

The control unit 949 includes a processor such as a CPU and a memory such as a RAM and a ROM. The memory stores a program executed by the CPU as well as program data. The program stored in the memory is read by the CPU at the start-up of the recording/reproducing device 940 and executed, for example. By executing the program, the CPU controls the operation of the recording/reproducing device 940 in accordance with an operation signal that is input from the user interface 950, for example.

The user interface 950 is connected to the control unit 949. The user interface 950 includes a button and a switch for a user to operate the recording/reproducing device 940 as well as a reception part which receives a remote control signal, for example. The user interface 950 detects a user operation through these components, generates the operation signal, and outputs the generated operation signal to the control unit 949.

The encoder 943 in the recording/reproducing device 940 configured in the aforementioned manner has a function of the image encoding device 10 according to the aforementioned embodiment. On the other hand, the decoder 947 has a function of the image decoding device 60 according to the aforementioned embodiment. Accordingly, for scalable video coding and decoding of images by the recording/reproducing device 940, image data of enhancement layers can be encoded and decoded more efficiently.

### 5-4. Fourth Application Example

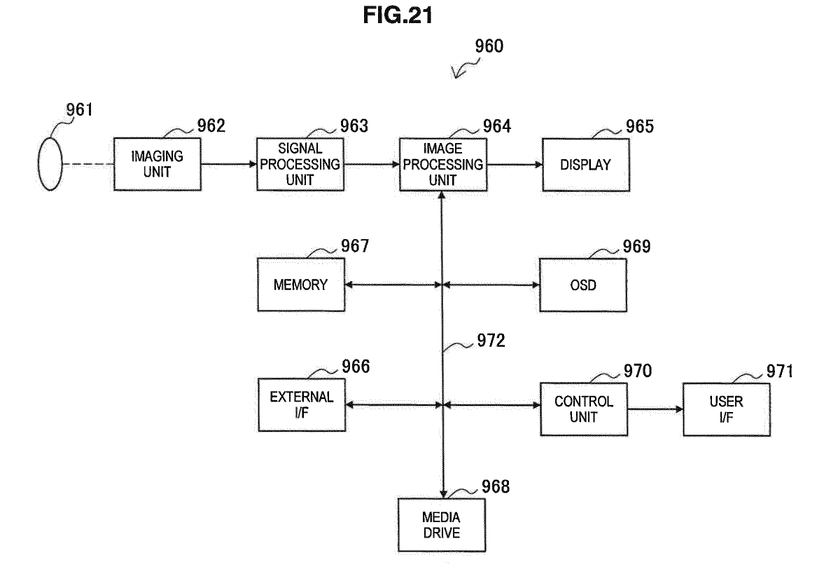

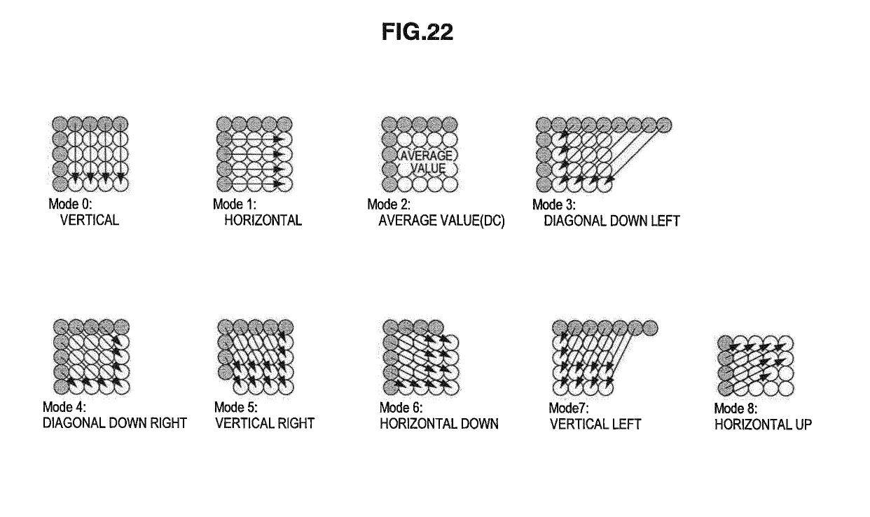

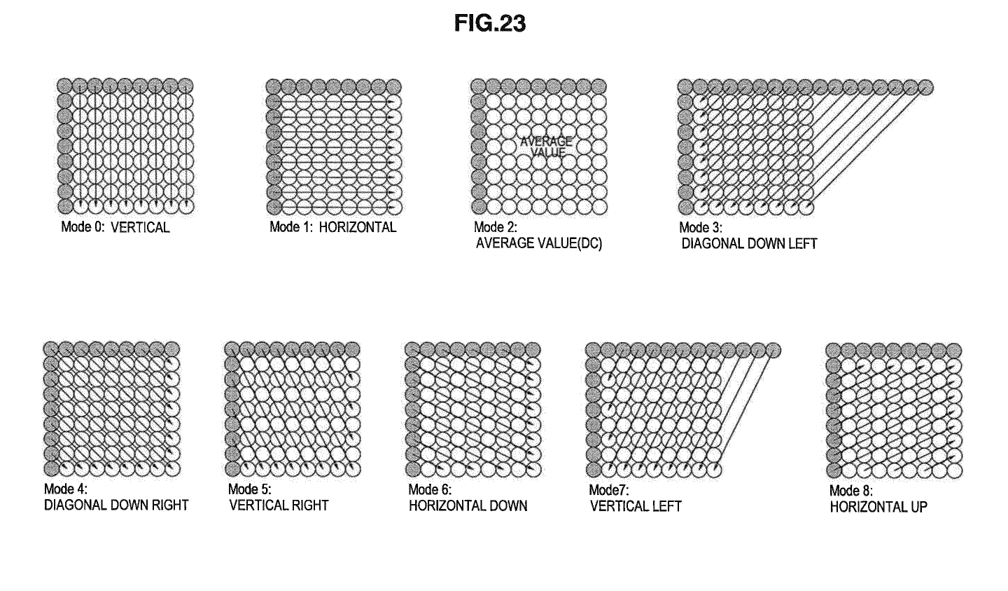

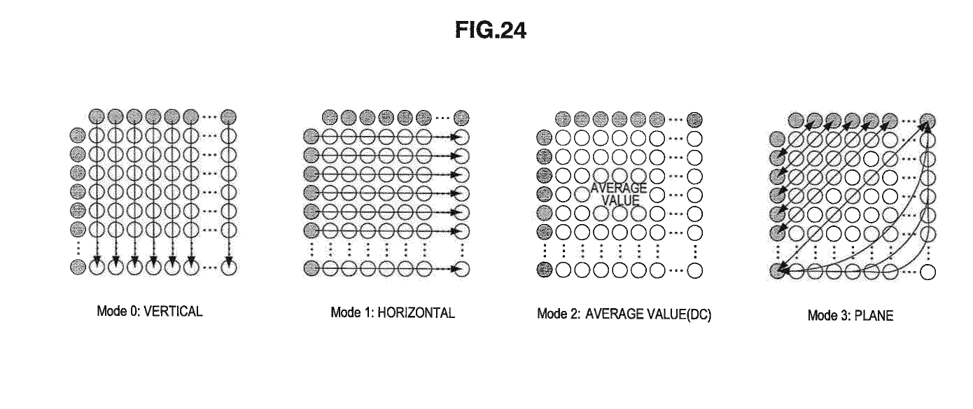

FIG. 21 is a diagram illustrating an example of a schematic configuration of an imaging device applying the aforementioned embodiment. An imaging device 960 images an object, generates an image, encodes image data, and records the data into a recording medium.

The imaging device 960 includes an optical block 961, an imaging unit 962, a signal processing unit 963, an image processing unit 964, a display 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display 965 is connected to the image processing unit 964. The user interface 971 is connected to the control unit 970. The bus 972 mutually connects the image processing unit 964, the external interface 966, the memory 967, the media drive 968, the OSD 969, and the control unit 970.

The optical block 961 includes a focus lens and a diaphragm mechanism. The optical block 961 forms an optical image of the object on an imaging surface of the imaging unit 962. The imaging unit 962 includes an image sensor such as a CCD (Charge Coupled Device) or a CMOS (Complementary Metal Oxide Semiconductor) and performs photoelectric conversion to convert the optical image formed on the imaging surface into an image signal as an electric signal. Subsequently, the imaging unit 962 outputs the image signal to the signal processing unit 963.

The signal processing unit 963 performs various camera signal processes such as a knee correction, a gamma correction and a color correction on the image signal input from the imaging unit 962. The signal processing unit 963 outputs the image data, on which the camera signal process has been performed, to the image processing unit 964.

The image processing unit 964 encodes the image data input from the signal processing unit 963 and generates the encoded data. The image processing unit 964 then outputs the generated encoded data to the external interface 966 or the media drive 968. The image processing unit 964 also decodes the encoded data input from the external interface 966 or the media drive 968 to generate image data. The image processing unit 964 then outputs the generated image data to the display 965. Moreover, the image processing unit 964 may output to the display 965 the image data input from the signal processing unit 963 to display the image. Furthermore, the image processing unit 964 may superpose display data acquired from the OSD 969 onto the image that is output on the display 965.

The OSD 969 generates an image of a GUI such as a menu, a button, or a cursor and outputs the generated image to the image processing unit 964.

The external interface 966 is configured as a USB input/output terminal, for example. The external interface 966 connects the imaging device 960 with a printer when printing an image, for example. Moreover, a drive is connected to the external interface 966 as needed. A removable medium such as a magnetic disk or an optical disk is mounted to the drive, for example, so that a program read from the removable medium can be installed to the imaging device 960. The external interface 966 may also be configured as a network interface that is connected to a network such as a LAN or the Internet. That is, the external interface 966 has a role as transmission means in the imaging device 960.

The recording medium mounted to the media drive 968 may be an arbitrary removable medium that is readable and writable such as a magnetic disk, a magneto-optical disk, an optical disk, or a semiconductor memory. Furthermore, the recording medium may be fixedly mounted to the media drive 968 so that a non-transportable storage unit such as a built-in hard disk drive or an SSD (Solid State Drive) is configured, for example.

The control unit 970 includes a processor such as a CPU and a memory such as a RAM and a ROM. The memory stores a program executed by the CPU as well as program data. The program stored in the memory is read by the CPU at the start-up of the imaging device 960 and then executed. By executing the program, the CPU controls the operation of the imaging device 960 in accordance with an operation signal that is input from the user interface 971, for example.

The user interface 971 is connected to the control unit 970. The user interface 971 includes a button and a switch for a user to operate the imaging device 960, for example. The user interface 971 detects a user operation through these components, generates the operation signal, and outputs the generated operation signal to the control unit 970.

The image processing unit 964 in the imaging device 960 configured in the aforementioned manner has a function of the image encoding device 10 and the image decoding device 60 according to the aforementioned embodiment. Accordingly, for scalable video coding and decoding of images by the imaging device 960, image data of enhancement layers can be encoded and decoded more efficiently.

### 6. Summary

Heretofore, the image encoding device 10 and the image decoding device 60 according to an embodiment have been described using FIGS. 1 to 21. According to the present embodiment, even when the number of intra prediction mode candidates of a prediction unit of the upper layer is different from the number of prediction mode candidates of the corresponding prediction unit of the lower layer for scalable video coding or decoding of an image, the prediction mode selected based on the prediction mode set to the prediction unit of the lower layer is set to the prediction unit of the upper layer. Therefore, the amount of code accompanying encoding of prediction mode information of the upper layer can be reduced. Particularly in HEVC in which the range of block size is extended and candidate sets of prediction mode are diversified, the amount of code generated when prediction mode information is encoded as it is not small and thus, the aforementioned mechanism capable of omitting most of the amount of code of prediction mode information of the upper layer is useful.

Also according to the present embodiment, when the number of prediction mode candidates of the upper layer is larger than that of the lower layer, the prediction mode set to the upper layer is selected using a parameter encoded in accordance with a difference of the prediction direction. By introducing such an additional parameter having a small number of bits while avoiding encoding of prediction mode information of the upper layer, prediction accuracy of an intra prediction of the upper layer can be improved and, as a result, the coding efficiency can be enhanced. The parameter is encoded with a smaller code number with a decreasing absolute value of a difference of the prediction direction between layers. Normally, there is a correlation between partial images in the same position between prediction units corresponding to two layers that are different only in spatial resolution. Therefore, more code words whose variable-length encoding is short can be used by encoding the parameter with a smaller code number with a decreasing difference of the prediction direction. As a result, the coding efficiency is further enhanced.

Also according to the present embodiment, when the number of prediction mode candidates of the upper layer is smaller than that of the lower layer, the prediction mode representing the prediction direction closest to the prediction direction of the lower layer to the prediction unit of the upper layer. Therefore, in this case, the prediction mode of the upper layer can appropriately be selected without needing an additional parameter.

Also according to the present embodiment, Most Probable Mode based on the prediction mode set to the corresponding prediction unit in the lower layer and the prediction mode of a reference block in the same layer can be realized. Accordingly, the accuracy of intra prediction can further be improved while reducing the amount of code of prediction mode information.

Mainly described herein is the example where the various pieces of information such as the information related to intra prediction and the information related to inter prediction are multiplexed to the header of the encoded stream and transmitted from the encoding side to the decoding side. The method of transmitting these pieces of information however is not limited to such example. For example, these pieces of information may be transmitted or recorded as separate data associated with the encoded bit stream without being multiplexed to the encoded bit stream. Here, the term “association” means to allow the image included in the bit stream (may be a part of the image such as a slice or a block) and the information corresponding to the current image to establish a link when decoding. Namely, the information may be transmitted on a different transmission path from the image (or the bit stream). The information may also be recorded in a different recording medium (or a different recording area in the same recording medium) from the image (or the bit stream). Furthermore, the information and the 30 image (or the bit stream) may be associated with each other by an arbitrary unit such as a plurality of frames, one frame, or a portion within a frame.

The preferred embodiments of the present disclosure have been described above with reference to the accompanying drawings, whilst the present disclosure is not limited to the above examples, of course. A person skilled in the art may find various alternations and modifications within the scope of the appended claims, and it should be understood that they will naturally come under the technical scope of the present disclosure.

(1)

An image processing apparatus including:

a mode setting section that, when a number of candidates of an intra prediction mode of a first prediction unit in a first layer of an image to be scalable-video-decoded containing the first layer and a second layer, which is an upper layer of the first layer, is different from the number of candidates of the intra prediction mode of a second prediction unit corresponding to the first prediction unit in the second layer, sets the prediction mode selected based on the prediction mode set to the first prediction unit to the second prediction unit; and a prediction section that generates a predicted image of the second prediction unit according to the prediction mode set by the mode setting section.

(2)

The image processing apparatus according to (1), further including:

a parameter acquisition section that, when the number of the candidates of the intra prediction mode of the first prediction unit is smaller than the number of the candidates of the intra prediction mode of the second prediction unit, acquires a first parameter encoded in accordance with a difference of a prediction direction between the first prediction unit and the second prediction unit,

wherein the mode setting section selects the prediction mode set to the second prediction unit in accordance with the first parameter acquired by the parameter acquisition section.

(3)

The image processing apparatus according to (2), wherein the first parameter is encoded with a smaller code number with a decreasing absolute value of the difference of the prediction direction.

(4)

The image processing apparatus according to (3), wherein the smaller code number is allocated to, between the differences of the prediction direction that are different only in whether positive or negative, the difference that rotates the prediction direction in a specific rotation direction.

(5)

The image processing apparatus according to (3), wherein the smaller code number is allocated to, between the differences of the prediction direction that are different only in whether positive or negative, the difference that brings the prediction direction of the second prediction unit closer to a specific direction.

(6)

The image processing apparatus according to (5), wherein the specific direction is a vertical direction or a horizontal direction and is decided in accordance with an aspect ratio of the image.

(7)

The image processing apparatus according to any one of (1) to (6), wherein when the number of the candidates of the intra prediction mode of the first prediction unit is larger than the number of the candidates of the intra prediction mode of the second prediction unit, the mode setting section sets the prediction mode representing the prediction direction closest to the prediction direction of the first prediction unit to the second prediction unit.

(8)

The image processing apparatus according to (7), wherein when a plurality of the prediction modes representing the prediction direction closest to the prediction direction of the first prediction unit is present in the candidates of the prediction mode of the second prediction unit, the mode setting section sets the prediction mode representing an average value prediction to the second prediction unit.

(9)

The image processing apparatus according to (7), wherein when a plurality of the prediction modes representing the prediction direction closest to the prediction direction of the first prediction unit is present in the candidates of the prediction mode of the second prediction unit, the mode setting section selects one of the plurality of prediction modes representing the closest prediction direction according to pre-defined conditions.

(10)

The image processing apparatus according to (9), wherein the pre-defined conditions are conditions that the prediction direction is rotated in a predetermined rotation direction.

(11)

The image processing apparatus according to (9), wherein the pre-defined conditions are conditions that a smaller code number is selected.

(12)

The image processing apparatus according to (7), further including:

a parameter acquisition section that, when the plurality of prediction modes representing the prediction direction closest to the prediction direction of the first prediction unit is present in the candidates of the prediction mode of the second prediction unit, acquires a second parameter to select the prediction mode,

wherein the mode setting section selects one of the plurality of prediction modes representing the closest prediction direction in accordance with the second parameter acquired by the parameter acquisition section.

(13)

The image processing apparatus according to (1), wherein the mode setting section estimates the prediction mode to be set to the second prediction unit by Most Probable Mode based on the prediction mode set to the first prediction unit and the prediction mode set to at least a third prediction unit adjacent to the second prediction unit in the second layer.

(14)

The image processing apparatus according to (13), wherein the mode setting section decides the Most Probable Mode after converting the prediction mode set to the first prediction unit into the prediction mode in the candidates of the prediction mode of the second prediction unit.

(15)

The image processing apparatus according to any one of (1) to (14), wherein the first prediction unit is a prediction unit in the first layer having a pixel corresponding to the pixel in a predetermined position in the second prediction unit.

(16)

An image processing method including:

when a number of candidates of an intra prediction mode of a first prediction unit in a first layer of an image to be scalable-video-decoded containing the first layer and a second layer, which is an upper layer of the first layer, is different from the number of candidates of the intra prediction mode of a second prediction unit corresponding to the first prediction unit in the second layer, setting the prediction mode selected based on the prediction mode set to the first prediction unit to the second prediction unit; and

generating a predicted image of the second prediction unit according to the set prediction mode.

(17)

An image processing apparatus including:

a mode setting section that, when a number of candidates of an intra prediction mode of a first prediction unit in a first layer of an image to be scalable-video-coded containing the first layer and a second layer, which is an upper layer of the first layer, is different from the number of candidates of the intra prediction mode of a second prediction unit corresponding to the first prediction unit in the second layer, sets the prediction mode selected based on the prediction mode set to the first prediction unit to the second prediction unit; and

a prediction section that generates a predicted image of the second prediction unit according to the prediction mode set by the mode setting section.

(18)

An image processing method including:

when a number of candidates of an intra prediction mode of a first prediction unit in a first layer of an image to be scalable-video-coded containing the first layer and a second layer, which is an upper layer of the first layer, is different from the number of candidates of the intra prediction mode of a second prediction unit corresponding to the first prediction unit in the second layer, setting the prediction mode selected based on the prediction mode set to the first prediction unit to the second prediction unit; and

generating a predicted image of the second prediction unit according to the set prediction mode.

### REFERENCE SIGNS LIST

10 image encoding device (image processing apparatus)
41 mode setting section
42 prediction section
45 parameter generation section
60 image decoding device (image processing apparatus)
91 parameter acquisition section
92 mode setting section
94 prediction section

1. An image processing apparatus comprising:
a mode setting section that, when a number of candidates of an intra prediction mode of a first prediction unit in a first layer of an image to be scalable-video-decoded containing the first layer and a second layer, which is an upper layer of the first layer, is different from the number of candidates of the intra prediction mode of a second prediction unit corresponding to the first prediction unit in the second layer, sets the prediction mode selected based on the prediction mode set to the first prediction unit to the second prediction unit; and
a prediction section that generates a predicted image of the second prediction unit according to the prediction mode set by the mode setting section.

2. The image processing apparatus according to claim 1, further comprising:
a parameter acquisition section that, when the number of the candidates of the intra prediction mode of the first prediction unit is smaller than the number of the candidates of the intra prediction mode of the second prediction unit, acquires a first parameter encoded in accordance with a difference of a prediction direction between the first prediction unit and the second prediction unit,
wherein the mode setting section selects the prediction mode set to the second prediction unit in accordance with the first parameter acquired by the parameter acquisition section.

3. The image processing apparatus according to claim 2, wherein the first parameter is encoded with a smaller code number with a decreasing absolute value of the difference of the prediction direction.

4. The image processing apparatus according to claim 3, wherein the smaller code number is allocated to, between the differences of the prediction direction that are different only in whether positive or negative, the difference that rotates the prediction direction in a specific rotation direction.

5. The image processing apparatus according to claim 3, wherein the smaller code number is allocated to, between the differences of the prediction direction that are different only in whether positive or negative, the difference that brings the prediction direction of the second prediction unit closer to a specific direction.

6. The image processing apparatus according to claim 5, wherein the specific direction is a vertical direction or a horizontal direction and is decided in accordance with an aspect ratio of the image.

7. The image processing apparatus according to claim 1, wherein when the number of the candidates of the intra prediction mode of the first prediction unit is larger than the number of the candidates of the intra prediction mode of the second prediction unit, the mode setting section sets the prediction mode representing the prediction direction closest to the prediction direction of the first prediction unit to the second prediction unit.

8. The image processing apparatus according to claim 7, wherein when a plurality of the prediction modes representing the prediction direction closest to the prediction direction of the first prediction unit is present in the candidates of the prediction mode of the second prediction unit, the mode setting section sets the prediction mode representing an average value prediction to the second prediction unit.

9. The image processing apparatus according to claim 7, wherein when a plurality of the prediction modes representing the prediction direction closest to the prediction direction of the first prediction unit is present in the candidates of the prediction mode of the second prediction unit, the mode setting section selects one of the plurality of prediction modes representing the closest prediction direction according to pre-defined conditions.

10. The image processing apparatus according to claim 9, wherein the pre-defined conditions are conditions that the prediction direction is rotated in a predetermined rotation direction.

11. The image processing apparatus according to claim 9, wherein the pre-defined conditions are conditions that a smaller code number is selected.

12. The image processing apparatus according to claim 7, further comprising:
a parameter acquisition section that, when the plurality of prediction modes representing the prediction direction closest to the prediction direction of the first prediction unit is present in the candidates of the prediction mode of the second prediction unit, acquires a second parameter to select the prediction mode,
wherein the mode setting section selects one of the plurality of prediction modes representing the closest prediction direction in accordance with the second parameter acquired by the parameter acquisition section.

13. The image processing apparatus according to claim 1, wherein the mode setting section estimates the prediction mode to be set to the second prediction unit by Most Probable Mode based on the prediction mode set to the first prediction unit and the prediction mode set to at least a third prediction unit adjacent to the second prediction unit in the second layer.

14. The image processing apparatus according to claim 13, wherein the mode setting section decides the Most Probable Mode after converting the prediction mode set to the first prediction unit into the prediction mode in the candidates of the prediction mode of the second prediction unit.

15. The image processing apparatus according to claim 1, wherein the first prediction unit is a prediction unit in the first layer having a pixel corresponding to the pixel in a predetermined position in the second prediction unit.

16. An image processing method comprising:
when a number of candidates of an intra prediction mode of a first prediction unit in a first layer of an image to be scalable-video-decoded containing the first layer and a second layer, which is an upper layer of the first layer, is different from the number of candidates of the intra prediction mode of a second prediction unit corresponding to the first prediction unit in the second layer, setting the prediction mode selected based on the prediction mode set to the first prediction unit to the second prediction unit; and
generating a predicted image of the second prediction unit according to the set prediction mode.

17. An image processing apparatus comprising:
a mode setting section that, when a number of candidates of an intra prediction mode of a first prediction unit in a first layer of an image to be scalable-video-coded containing the first layer and a second layer, which is an upper layer of the first layer, is different from the number of candidates of the intra prediction mode of a second prediction unit corresponding to the first prediction unit in the second layer, sets the prediction mode selected based on the prediction mode set to the first prediction unit to the second prediction unit; and
a prediction section that generates a predicted image of the second prediction unit according to the prediction mode set by the mode setting section.

18. An image processing method comprising:
when a number of candidates of an intra prediction mode of a first prediction unit in a first layer of an image to be scalable-video-coded containing the first layer and a second layer, which is an upper layer of the first layer, is different from the number of candidates of the intra prediction mode of a second prediction unit corresponding to the first prediction unit in the second layer, setting the prediction mode selected based on the prediction mode set to the first prediction unit to the second prediction unit; and
generating a predicted image of the second prediction unit according to the set prediction mode.
